(19) United States
(12) Patent Application Publication
(10) Pub. No.: US 2013/0082560 A1
(43) Pub. Date: Apr. 4, 2013

(54) CORELESS ELECTROMECHANICAL DEVICE, MOBILE UNIT, ROBOT, AND MANUFACTURING METHOD OF CORELESS ELECTROMECHANICAL DEVICE

(71) Applicant: Seiko Epson Corporation, Tokyo (JP)

(72) Inventors: Kesatoshi TAKEUCHI, Shiojiri (JP); Kazuyoshi NAKAMURA, Azumino (JP)

(73) Assignee: Seiko Epson Corporation, Tokyo (JP)

(21) Appl. No.: 13/623,358

(22) Filed: Sep. 20, 2012

(30) Foreign Application Priority Data
Sep. 29, 2011 (JP) 2011-215035

(51) Int. Cl. H02K 3/00; H02K 15/03

(52) U.S. Cl. CPC H02K 3/00; H02K 15/03
USPC 310/156.01; 29/598

(57) ABSTRACT

A coreless electromechanical device includes permanent magnets provided in a first member, M (M is an integer number equal to or more than two) phases of α-wound air core electromagnetic coils provided in a second member, and a coil back yoke provided in the second member, wherein the electromagnetic coil has two effective coil regions that generate force for relative rotational transfer of the first member with respect to the second member and two coil end regions, and the coil end regions of at least the (M-1) phases of electromagnetic coils of the M phases of electromagnetic coils are bent toward an inner circumference side or an outer circumference side of a cylindrical surface containing the cylindrical region so as not to interfere with the coil end regions of the other phases of electromagnetic coils.

### BACKGROUND

1. Technical Field

The present invention relates to a coreless electromechanical device, a mobile unit, a robot, and a manufacturing method of the coreless electromechanical device.

2. Related Art

Slotless motors in which plural air core coils are sandwiched between insulating film sheets, and thereby, a space factor of the coils (electromagnetic coils) is improved has been known (for example, Patent Document 1 (JP-A-2001-231204).

However, in related art, spaces are left in the parts corresponding to the cores of the electromagnetic coils, and further improvement in space factor has not been sufficiently studied.

### SUMMARY

An advantage of some aspects of the invention is to improve a space factor of electromagnetic coils and improve efficiency of a coreless electric motor (coreless electromechanical device).

The invention may be implemented as the following embodiments and application examples.

### APPLICATION EXAMPLE 1

This application example is directed to a coreless electromechanical device having first and second cylindrical members movable relative to each other. The coreless electromechanical device includes permanent magnets provided in the first member, M (M is an integer number equal to or more than two) phases of α-wound air core electromagnetic coils provided in the second member, and a coil back yoke provided in the second member, wherein the electromagnetic coil has two effective coil regions that generate force for relative rotational transfer of the first member with respect to the second member and two coil end regions, a total of the M electromagnetic coils respectively selected for each phase from the M phases of electromagnetic coils form a coil sub-assembly, in the coil sub-assembly, shapes of the effective coil regions of the M phases of electromagnetic coils respectively have the same shape, the effective coil regions extend along a direction in parallel to an axis direction of the rotation in a cylindrical region between the permanent magnets and the coil back yoke, and the whole M phases of electromagnetic coils are arranged in a circumference direction of the cylindrical region, a distance between the two effective coil regions of the electromagnetic coil is (M-1) times a width of the electromagnetic coil in the effective coil region of the electromagnetic coil, a first phase of electromagnetic coils of the M phases of electromagnetic coils have one effective coil region of the two effective coil regions of the other (M-1) phases of electromagnetic coils than the first phase of electromagnetic coils between the two effective coil regions, and the coil end regions of at least the (M-1) phases of electromagnetic coils of the M phases of electromagnetic coils are bent toward an inner circumference side or an outer circumference side of a cylindrical surface containing the cylindrical region so as not to interfere with the coil end regions of the other phases of electromagnetic coils, and the coil sub-assemblies are arranged in contact with the adjacent coil sub-assemblies in the circumference direction of the cylindrical region.

According to this application example, a coil assembly in which the effective coil regions of the first phase of electromagnetic coils are filled with bundles of conductors forming the effective coil regions of the other phases of electromagnetic coils so that adjacent bundles of conductors may be in contact with no space, a pluralities of the coil assemblies are arranged so that the coil assemblies may not overlap and the adjacent coil assemblies may be in contact, and thus, the space factor of the electromagnetic coils may be improved, and the efficiency of the coreless electromechanical device may be improved.

### APPLICATION EXAMPLE 2

This application example is directed to the coreless electromechanical device according to Application Example 1, wherein the coil end regions of the first phase of electromagnetic coils are not bent and provided on the cylindrical surface.

According to this application example, the coil end regions of the first phase of electromagnetic coils are not bent toward the inner side or the outer side of the cylindrical surface and, even when they exist on the cylindrical surface, the inductances of the first phase of electromagnetic coils may be made substantially equal to the inductances of other (M-1) phases of electromagnetic coils, and thus, the Lorentz force by the M-phase of electromagnetic coils may be well balanced and the efficiency of the coreless electromechanical device may be improved.

### APPLICATION EXAMPLE 3

This application example is directed to the coreless electromechanical device according to Application Example 1 or 2, which includes the electromagnetic coils having the coil end regions bent toward outside of the cylindrical surface and the electromagnetic coils having the coil end regions bent toward inside of the cylindrical surface.

According to this application example, the differences between the inductances of the phase of the electromagnetic coils having the coil end regions bent toward the inside of the cylindrical surface and the inductances of the phase of the electromagnetic coils having the coil end regions bent toward the outside of the cylindrical surface are smaller, and thus, variations in inductance may be suppressed to be smaller.

### APPLICATION EXAMPLE 4

This application example is directed to the coreless electromechanical device according to any one of Application Examples 1 to 3, wherein when a value of M is equal to or more than three, the coil end regions of the electromagnetic coils are bent toward the inner circumference side or the outer circumference side of the cylindrical region indifferent sizes with respect to each phase.

According to this application example, the electromagnetic coils may be suppressed from interference.

### APPLICATION EXAMPLE 5

This application example is directed to the coreless electromechanical device according to any one of Application Examples 1 to 4, wherein the shapes of the coil end regions of the electromagnetic coils included in the respective phases of groups of coils before bent are the same shape and the electromagnetic coils have the same electrical resistance value.

According to this application example, the electromagnetic coils have the same shape, i.e., the same electrical resistance and the same inductance when their coil end regions are not bent but flat, the parts of the coil ends that hardly affect the values of the inductances are formed with respect to the electromagnetic coils, and thus, the electrical resistances and the inductances of the electromagnetic coils after bent are substantially equal. As a result, Lorentz force by the M-phase of electromagnetic coils may be well balanced and the efficiency of the coreless electromechanical device may be improved.

### APPLICATION EXAMPLE 6

This application example is directed to the coreless electromechanical device according to any one of Application Examples 1 to 5, wherein materials of conductors forming the electromagnetic coils are the same material, diameters of the conductors are the same, the numbers of turns of the conductors of the electromagnetic coils are the same, and the electromagnetic coils have the same electrical resistance value.

According to this application example, the materials of the conductors forming the electromagnetic coils are the same material, the diameters of the conductors are the same, the numbers of turns of the conductors of the electromagnetic coils are the same, and thus, the inductances of the electromagnetic coils may be made equal.

### APPLICATION EXAMPLE 7

This application example is directed to a mobile unit including the coreless electromechanical device according to any one of Application Examples 1 to 6.

### APPLICATION EXAMPLE 8

This application example is directed to a robot including the coreless electromechanical device according to any one of Application Examples 1 to 6.

### APPLICATION EXAMPLE 9

This application example is directed to a manufacturing method of a careless electromechanical device having M (M is an integer number equal to or more than two) phases of α-wound electromagnetic coils, including (a) preparing M cylindrical pieces of the α-wound electromagnetic coils respectively having effective coil regions of the electromagnetic coils in the same shape and having electric resistance values of the electromagnetic coils in the same magnitude by winding a conductor at N (N is an integer number equal to or more than two) times, (b) bending coil end regions of at least (M-1) electromagnetic coils of the M electromagnetic coils toward inner circumference sides or outer circumference sides of the cylindrical pieces not to interfere with the coil end regions of the other electromagnetic coils, (c) forming a coil sub-assembly having a structure in which a first phase of electromagnetic coils include one effective coil region of the two effective coil regions of the other (M-1) phases of electromagnetic coils than the first phase of electromagnetic coils between the two effective coil regions using a total of M cylindrical pieces of electromagnetic coils for phase from the cylindrical pieces of the M phases of electromagnetic coils, (d) forming the electromagnetic coils provided in a cylindrical shape by arranging the P (P is an integer number equal to or more than two) coil sub-assemblies in a circumference direction of a cylindrical region so that the adjacent coil sub-assemblies may be in contact, (e) providing a coil back yoke at an outer circumference side of the cylindrical region of the electromagnetic coils provided in the cylindrical shape, and (f) providing a rotation axis having permanent magnets at an inner circumference side of the cylindrical region of the electromagnetic coils provided in the cylindrical shape.

According to this application example, the coil sub-assemblies are formed, then, the electromagnetic coils are formed by arranging the coil sub-assemblies in the cylindrical shape, and thus, the coreless electromechanical device may be easily manufactured.

### APPLICATION EXAMPLE 10

This application example is directed to a manufacturing method of a coreless electromechanical device having M (M is an integer number equal to or more than two) phases of electromagnetic coils, including (a) preparing P (P is an integer number equal to or more than two) cylindrical pieces of electromagnetic coils respectively having effective coil regions of the electromagnetic coils in the same shape and having electric resistance values of the electromagnetic coils in the same magnitude with respect to each phase by winding a conductor at N (N is an integer number equal to or more than two) times, (b) bending coil end regions of at least (M-1) phases of electromagnetic coils of the M phases of electromagnetic coils toward inner circumference sides or outer circumference sides of the cylindrical pieces not to interfere with the coil end regions of the other phases of electromagnetic coils, (c) forming a coil sub-assembly having a structure in which a first phase of electromagnetic coils include one effective coil region of the two effective coil regions of the other (M-1) phases of electromagnetic coils than the first phase of electromagnetic coils between the two effective coil regions using a total of M cylindrical pieces of electromagnetic coils for each phase from the cylindrical pieces of the M phases of electromagnetic coils, (d) preparing a coil back yoke having a cylindrical shape, (e) forming the electromagnetic coils provided in a cylindrical shape by arranging the P coil sub-assemblies in a circumference direction of a cylindrical region at an inner circumference side of the coil back yoke so that the adjacent coil sub-assemblies may be in contact, and (f) providing a rotation axis having permanent magnets at an inner circumference side of the cylindrical region of the electromagnetic coils provided in the cylindrical shape. According to this application example, the coil sub-assemblies are arranged from the inside of the coil back yoke, and thus, the coil back yoke without the split structure may be used. Note that embodiments of the invention may be realized in various forms, and may be realized in forms not only of the coreless electromechanical device such as a motor or a power generator but also a mobile unit, a robot, or the like using the device.

### BRIEF DESCRIPTION OF THE DRAWINGS

The invention will be described with reference to the accompanying drawings, wherein like numbers reference like elements.

FIGS. 1A and 1B are explanatory diagrams showing the first embodiment.

FIG. 2 is an explanatory diagram showing relationships between distances from a permanent magnet surface to a coil back yoke and magnetic flux density.

FIG. 3A is a diagram with marks X by broken lines in boundary parts between the adjacent same phase of electromagnetic coils in FIG. 1B.

FIG. 3B is a graph showing an electrical angle of a coreless motor, induced voltages of electromagnetic coils, and magnetic flux density sensed by a magnetic sensor (FIG. 1A).

FIG. 4A illustrates explanatory diagrams (1) showing a formation step of the electromagnetic coil.

FIG. 4B illustrates explanatory diagrams (2) showing the formation step of the electromagnetic coil.

FIG. 4C illustrates explanatory diagrams (3) showing the formation step of the electromagnetic coil.

FIG. 4D illustrates explanatory diagrams showing an overlapping step of electromagnetic coils.

FIG. 4E illustrates explanatory diagrams showing an overlapping state of the electromagnetic coils.

FIG. 5 is an explanatory diagram schematically showing wiring of the electromagnetic coils in the first embodiment.

FIGS. 6A and 6B are explanatory diagrams showing the second embodiment.

FIG. 7A is a diagram showing locations with marks X by broken lines in FIG. 6B corresponding to the locations with the marks X in FIG. 3A.

FIG. 7B is a graph showing an electrical angle of a coreless motor, induced voltages of electromagnetic coils, and magnetic flux density sensed by a magnetic sensor (FIG. 6A).

FIG. 8 is an explanatory diagram schematically showing wiring of the electromagnetic coils in the second embodiment.

FIG. 9A is an enlarged explanatory diagram showing the part with the mark X in FIG. 3A.

FIG. 9B is an enlarged explanatory diagram showing the part with the mark X in FIG. 7A.

FIG. 10 is an explanatory diagram for comparison between characteristics of the coreless motors of the first and second embodiments and characteristics of a cored motor and a coreless motor in related art.

FIG. 11A is an explanatory diagram showing electrical resistances and inductances of electromagnetic coils in the coreless motor in related art.

FIG. 11B is an explanatory diagram showing electrical resistances and inductances in the coreless motor of the first embodiment.

FIG. 12A is an explanatory diagram for explanation of a forming step of the electromagnetic coil.

FIG. 12B is an explanatory diagram for explanation of a forming step of the electromagnetic coil.

FIG. 13A is an explanatory diagram showing an insulating film layer formation step on the electromagnetic coil.

FIG. 13B is an explanatory diagram showing an insulating film layer formation step on the electromagnetic coil.

FIG. 14 is an explanatory diagram showing an assembly step of the electromagnetic coils.

FIGS. 15A and 15B are explanatory diagrams (1) showing a part of a formation step of an electromagnetic coil assembly.

FIGS. 16A and 16B are explanatory diagrams (2) showing a part of the formation step of the electromagnetic coil assembly.

FIG. 17 is an explanatory diagram (3) showing a part of formation step of the electromagnetic coil assembly.

FIGS. 18A and 18B are explanatory diagrams (4) showing a part of the formation step of the electromagnetic coil assembly.

FIGS. 19A and 19B are explanatory diagrams (5) showing a part of the formation step of the electromagnetic coil assembly.

FIGS. 20A and 20B are explanatory diagrams (1) showing an example when the formation of the electromagnetic coil assembly is performed in another process.

FIGS. 21A and 21B are explanatory diagrams (2) showing the example when the formation of the electromagnetic coil assembly is performed in the other process.

FIG. 22 is an explanatory diagram (3) showing the example when the formation of the electromagnetic coil assembly is performed in the other process.

FIGS. 23A and 23B are explanatory diagrams (4) showing the example when formation of the electromagnetic coil assembly is performed in the other process.

FIGS. 24A and 24B are explanatory diagrams (5) showing the example when the formation step of the electromagnetic coil assembly is performed in the other process.

FIG. 25 is an explanatory diagram showing an electromagnetic coil assembly when the formation step of the electromagnetic coil assembly is performed in yet another process.

FIGS. 26A and 26B are explanatory diagrams (1) showing an example when the formation of the electromagnetic coil assembly is performed in yet another process.

FIGS. 27A and 27B are explanatory diagrams (2) showing the example when the formation of the electromagnetic coil assembly is performed in the yet other process.

FIGS. 28A and 28B are explanatory diagrams (3) showing the example when the formation of the electromagnetic coil assembly is performed in the yet other process.

FIGS. 29A and 29B are explanatory diagrams (4) showing the example when the formation of the electromagnetic coil assembly is performed in the yet other process.

FIGS. 30A and 30B are explanatory diagrams showing the third embodiment.

FIG. 31 is a graph showing an electrical angle of a coreless motor, induced voltages of electromagnetic coils, and magnetic flux density sensed by a magnetic sensor (FIG. 30A).

FIG. 32A is an explanatory diagram schematically showing wiring of the electromagnetic coils in the third embodiment.

FIG. 32B is an explanatory diagram schematically showing the electromagnetic coils in the third embodiment.

FIG. 32C illustrates explanatory diagrams showing a modified example of the third embodiment.

FIG. 32D is an explanatory diagram showing the fourth embodiment.

FIG. 32E is an explanatory diagram schematically showing a section structure when the fourth embodiment is cut along a plane perpendicular to a rotation axis.

FIG. 32F illustrates explanatory diagrams showing a section when the fourth embodiment is cut along a plane in parallel to the rotation axis.

FIG. 33 is an explanatory diagram showing an electric bicycle (electric power-assisted bicycle) as an example of a mobile unit using a motor/power generator according to a modified example of the invention.

FIG. 34 is an explanatory diagram showing an example of a robot using a motor according to a modified example of the invention.

FIG. 35 is an explanatory diagram showing an example of a double-arm seven-axial robot using a motor according to a modified example of the invention.

FIG. 36 is an explanatory diagram showing a railway vehicle using a motor according to a modified example of the invention.

### DESCRIPTION OF EXEMPLARY EMBODIMENTS

### First Embodiment

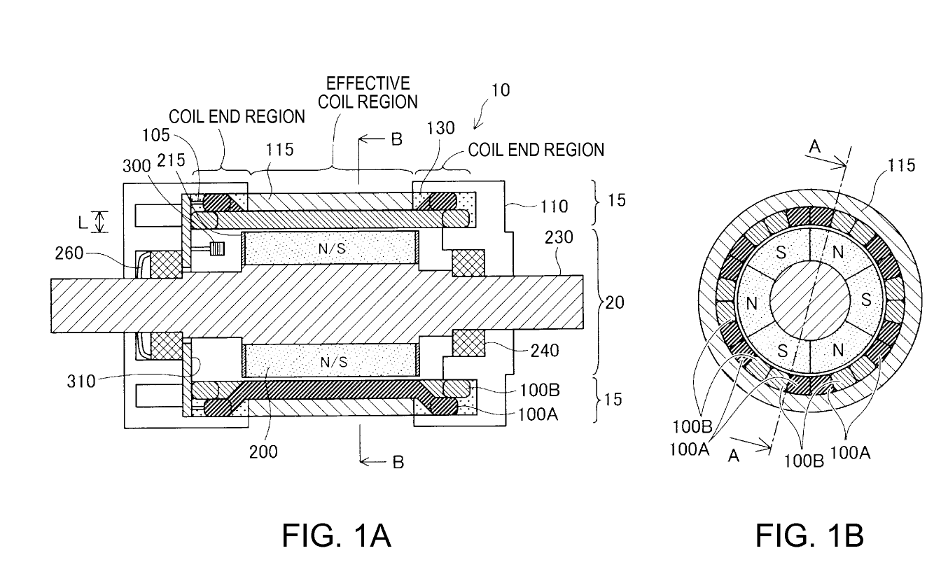

FIGS. 1A and 1B are explanatory diagrams showing the first embodiment. FIG. 1A is a diagram schematically showing a section of a coreless motor 10 cut along a section line (A-A in FIG. 1B) in parallel to a rotation axis 230 as seen from a direction perpendicular to the section, and FIG. 1B is a diagram schematically showing a section of the coreless motor 10 cut along a section line (B-B in FIG. 1A) perpendicular to the rotation axis 230 as seen from a direction perpendicular to the section. The coreless motor 10 is an inner-rotor motor having a radial gap structure in which a nearly cylindrical stator 15 is provided at the outer side and a nearly cylindrical rotor 20 is provided at the inner side. The stator 15 has a coil back yoke 115 provided along the inner circumference of a casing 110, and plural coreless electromagnetic coils 100A, 100B arranged inside of the coil back yoke 115. The coil back yoke 115 is formed using a magnetic material and has a nearly cylindrical shape. In the embodiment, when the electromagnetic coils 100A, 100B are not distinguished, they are simply referred to as “electromagnetic coils 100”. The electromagnetic coils 100A and the electromagnetic coils 100B are molded by a resin 130 and provided on the same cylindrical surface. Note that the coil back yoke 115 is molded by the resin 130 with the electromagnetic coils 100A, 100B, and the coil back yoke 115 is provided at the outer circumference side of the electromagnetic coils 100A, 100B. The length in the direction along the rotation axis 230 of the electromagnetic coils 100A, 100B is longer than the length in the direction along the rotation axis 230 of the coil back yoke 115. That is, in FIG. 1A, the ends of the electromagnetic coils 100A, 100B in the horizontal direction do not overlap with the coil back yoke 115. In the embodiment, regions overlapping with the coil back yoke 115 are referred to as “effective coil regions”, and regions not overlapping with the coil back yoke 115 are referred to as “coil end regions”. In the embodiment, the effective coil regions and the coil end regions of the electromagnetic coil 100B and the effective coil regions of the electromagnetic coil 100A are in the same cylindrical region, and the coil end regions of the electromagnetic coil 100A are bent outward from the cylindrical surface.

In the stator 15, a magnetic sensor 300 as a location sensor that detects the phase of the rotor 20 is further provided. As the magnetic sensor 300, for example, a Hall sensor IC having a signal amplifier circuit and a temperature compensating circuit with a Hall element may be used. The magnetic sensor 300 generates a sensor signal with nearly sine wave. The sensor signal is used for generation of a drive signal for driving the electromagnetic coil 100. Therefore, it is preferable that two magnetic sensors 300 corresponding to the electromagnetic coils 100A, 100B are provided. The magnetic sensors 300 are fixed onto a circuit board 310, and the circuit board 310 is fixed to the casing 110. Note that, in FIG. 1A, only one magnetic sensor 300 is shown, however, the coreless motor 10 may include two magnetic sensors respectively corresponding to the electromagnetic coils 100A, 100B.

The rotor 20 has the rotation axis 230 at the center and plural permanent magnets 200 on the outer circumference. Each permanent magnet 200 is magnetized in the radial direction from the center of the rotation axis 230 toward the outside. Note that, in FIG. 1B, characters N, S on the permanent magnets 200 show polarities at the electromagnetic coils 100A, 100B sides of the permanent magnets 200. The permanent magnets 200 and the electromagnetic coils 100 are provided to face the cylindrical surface on the opposed cylindrical surfaces of the rotor 50 and the stator 15. Here, the length in the direction along the rotation axis 230 of the permanent magnet 200 is the same as the length in the direction along the rotation axis 230 of the coil back yoke 115. That is, the region in which the region sandwiched between the permanent magnet 200 and the coil back yoke 115 overlaps with the electromagnetic coil 100A or 100B is the effective coil region. Here, the distance from the surface of the permanent magnet 200 to the coil back yoke 115 is referred to as “distance L”. On both ends in the direction along the rotation axis 230 of the permanent magnet 200, magnet back yokes 215 are provided. The magnet back yoke 215 suppresses leakage of the magnetic flux of the permanent magnets along the rotation axis 230. The rotation axis 230 is supported by a bearing 240 of the casing 110. In the embodiment, a wave spring washer 260 is provided inside of the casing 110. The wave spring washer 260 positions the permanent magnets 200. Note that the wave spring washer 260 may be replaced by another component part.

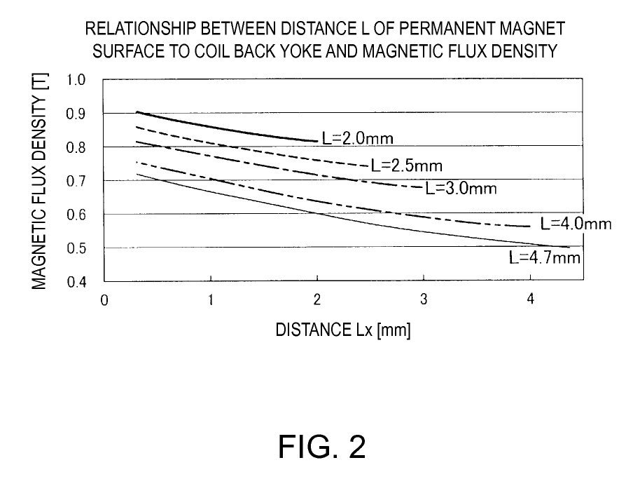

FIG. 2 is an explanatory diagram showing relationships between distances L from the permanent magnet surface to the coil back yoke and magnetic flux density. When the distance L between the permanent magnet surface and the coil back yoke is not changed, as the distance Lx from the surface of the permanent magnet 200 is larger, the magnetic flux density becomes smaller. Further, when the measurement location where the magnetic flux density is measured (the distance Lx from the permanent magnet) is constant, it is known that the smaller the distance L between the permanent magnet 200 and the coil back yoke 115, the larger the magnetic flux density. Therefore, the electromagnetic coil 100 is formed so that the thickness of the electromagnetic coil 100 may be smaller and the distance L between the permanent magnet 200 and the coil back yoke 115 is formed smaller, and thereby, the magnetic flux density applied to the electromagnetic coils 100 may be increased and the efficiency of the coreless motor 10 may be improved.

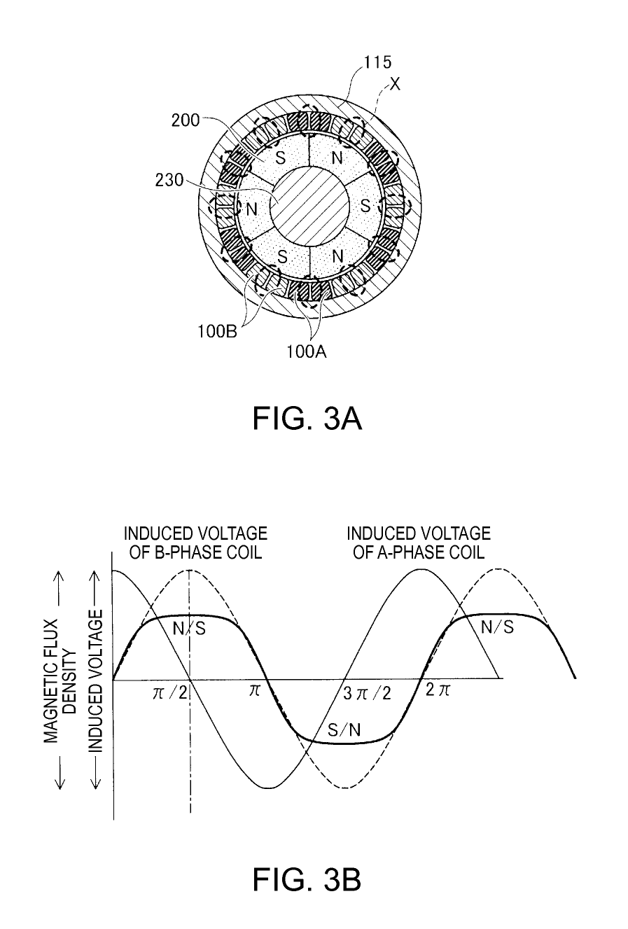

FIG. 3A is a diagram with marks X by broken lines in boundary parts between the adjacent same phase of electromagnetic coils in FIG. 1B. Note that it is preferable that the adjacent electromagnetic coils 100 contact each other, however, a slight gap is produced between the two electromagnetic coils 100A or two electromagnetic coils 100B due to the problem in the coil winding technology. FIG. 3A is different from FIG. 1B in that the gaps between the adjacent electromagnetic coils 100 are intensified. As described above, slight gaps are produced between the two electromagnetic coils 100A or two electromagnetic coils 100B due to the problem in the coil winding technology. In the gap, at the part that coincides with the pole center point of the permanent magnet 200 on the electrical angle (π/2 or 3π/2 in FIG. 3B), the maximum force F is produced by the maximum current flowing in the electromagnetic coil 100A or the electromagnetic coil 100B. Accordingly, the higher space factor of the electromagnetic coil is required in the gap. Here, the space factor refers to (sectional area of conductor of electromagnetic coil)/(sectional area of cylindrical region provided with electromagnetic coil). When the gap is produced between the two electromagnetic coils 100A or two electromagnetic coils 100B, no conductor of the electromagnetic coil exists in the gap, and the space factor becomes lower from 100%. Note that, as will be explained later, the effective coil regions of the two electromagnetic coils 100B are accommodated between the two effective coil regions of the electromagnetic coils 100A, and the significantly higher space factor may be maintained in the effective coil regions.

FIG. 3B is a graph showing an electrical angle of a coreless motor, induced voltages of electromagnetic coils, and magnetic flux density sensed by a magnetic sensor 300 (FIG. 1A). In FIG. 3B, the electrical angle when the boundary part between the two permanent magnets 200 coincides with the boundary between the two electromagnetic coils 100A (the state in FIG. 3A) is set to π/2. The magnetic flux density sensed by the magnetic sensor 300 becomes the maximum when the electrical angle is π/2 (3π/2), and becomes the minimum when the electrical angle is 0 (π, 2π). Further, the induced voltage of the electromagnetic coil 100B becomes the maximum when the electrical angle is π/2 (3π/2), and becomes zero when the electrical angle is 0 (π, 2π). On the other hand, the induced voltage of the electromagnetic coil 100A becomes zero when the electrical angle is π/2 (3π/2), and becomes the maximum when the electrical angle is 0 (π, 2π).

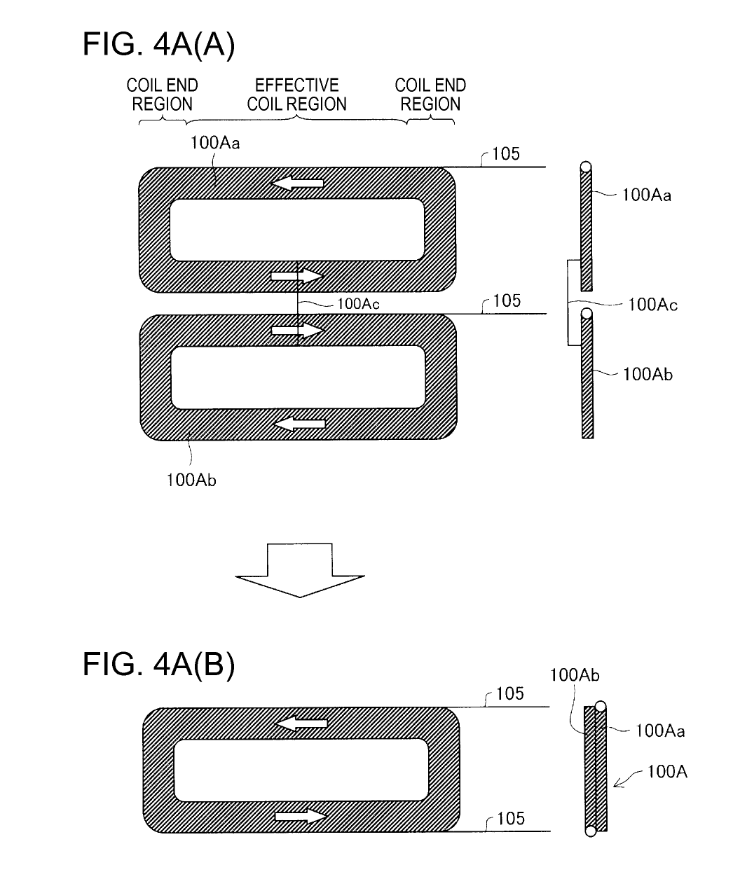

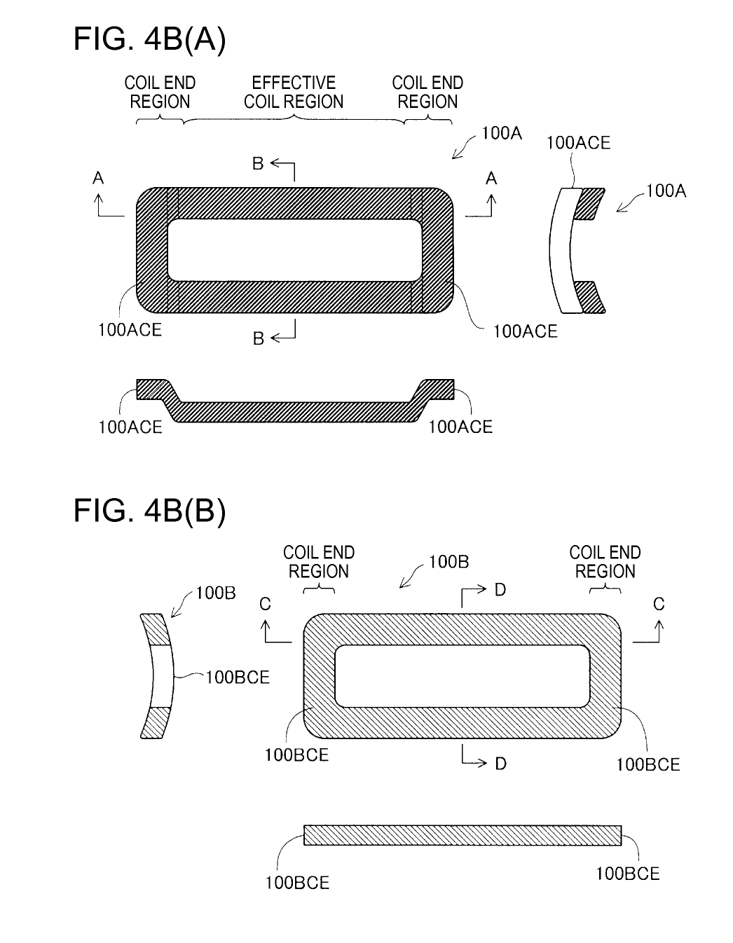

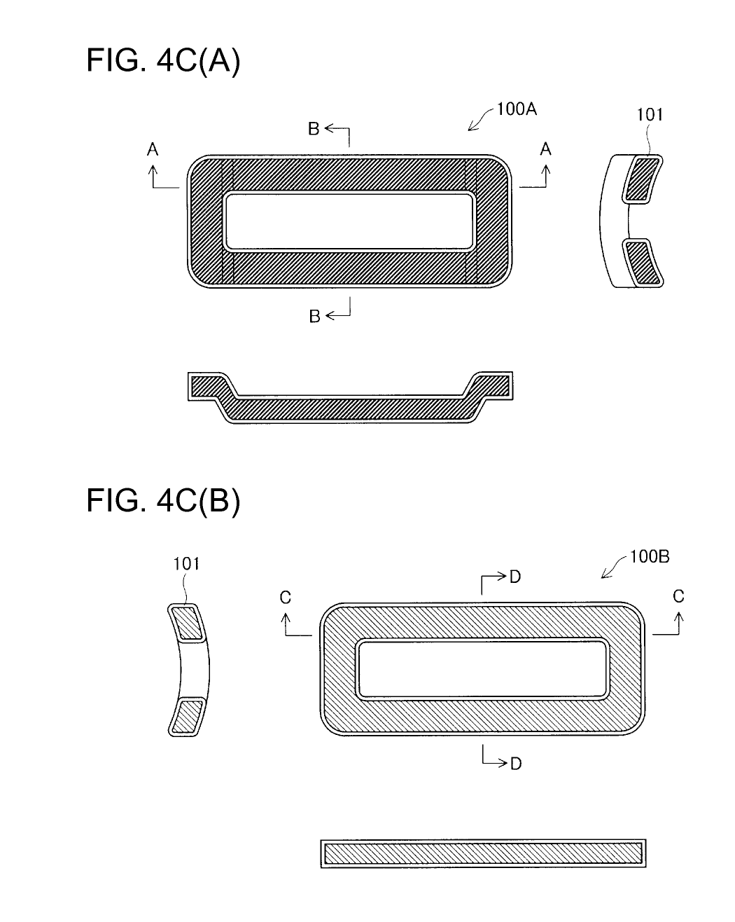

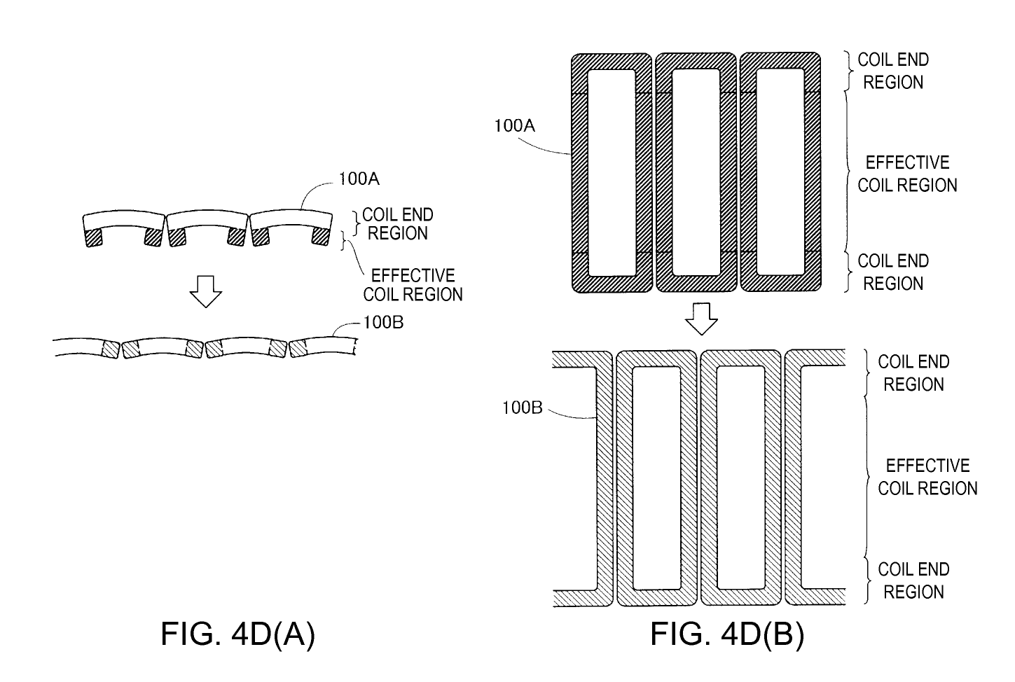

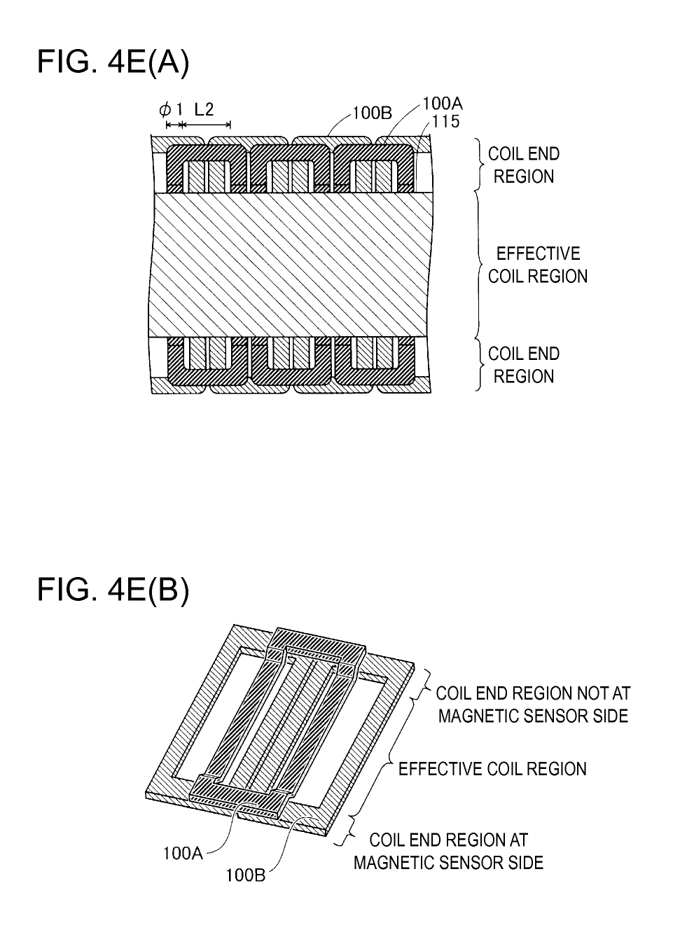

FIG. 4A illustrates explanatory diagrams (1) showing a formation step of the electromagnetic coil. The electromagnetic coils 100A, 100B may be formed in the same process before the coil end regions are bent toward outer circumference side or the inner circumference side from the cylindrical surface on which the effective coil regions of the electromagnetic coils 100A, 100B are provided. Accordingly, the electromagnetic coil 100A will be explained as an example. First, at the step shown in (A) in FIG. 4A, an electromagnetic coil wire 105 is prepared, both ends from nearly the center of the electromagnetic coil wire 105 are respectively wound outward in a winding, and two coil parts 100Aa and 100Ab are formed from one electromagnetic coil wire 105. The inner circumferences of the two coil parts 100Aa and 100Ab are connected to each other by a connection part 100Ac. Here, it is preferable to start winding of the two coil parts 100Aa and 100Ab so that the connection part 100Ac may have the length wired along the inner circumference of the coil part 100Aa when the coil parts 100Aa and 100Ab overlap. Note that the specific length of the connection part 100Ac varies depending on the location where the connection part 100Ac is drawn in the two coil parts 100Aa and 100Ab. For example, in the example shown in (A) in FIG. 4A, it is preferable that the length is a length integeral multiple of the length of the inner circumference of the coil part 100Aa or the coil part 100Ab.

Then, at the step shown in (B) in FIG. 4A, the electromagnetic coil 100A is formed by overlapping the two coil parts 100Aa and 100Ab on the opposed surfaces. In this regard, the connection part 100Ac is alone and the connection part 100Ac is wired along the inner circumference of the coil part 100Aa. As described above, when the length of the connection part 100Ac is at the length integral multiple of the length of the inner circumference of the coil part 100Aa or the coil part 100Ab, the connection part 100Ac may be wired along the inner circumference of the coil part 100Aa without excess or deficiency. In the embodiment, the two coil parts 100Aa and 100Ab are formed using the electromagnetic coil wire 105, and then, the α-wound electromagnetic coil 100A is formed by overlapping the two coil parts 100Aa and 100Ab on opposed surfaces. In the formation manner, the electromagnetic coil wire 105 to be drawn outward from the electromagnetic coil 100A is drawn from the outer circumference of the electromagnetic coil 100A. Therefore, the effective coil region and the coil end regions of the electromagnetic coil 100A do not cross the drawn electromagnetic coil wire 105, and are made harder to be affected by the magnetic flux generated in the electromagnetic coil wire 105. The electromagnetic coil 100B may be formed in the same manner. Note that it is preferable to use electromagnetic coil wire 105 having the same wire material, the same diameter, and the same value of specific resistance to form the electromagnetic coils 100A and 100B. The electrical resistance of the electromagnetic coil 100A and the electrical resistance of the electromagnetic coil 100B may be made to have the same value.

FIG. 4B illustrates explanatory diagrams (2) showing the formation step of the electromagnetic coil. (A) in FIG. 4B shows the electromagnetic coil 100A and the (B) in FIG. 4B shows the electromagnetic coil 100B. The lower left drawing in (A) in FIG. 4B shows a section cut along A-A section line in the upper left drawing, and the right drawing in (A) in FIG. 4B shows a section cut along B-B section line in the upper left drawing. The lower left drawing in (B) in FIG. 4B shows a section cut along C-C section line in the upper left drawing, and the right drawing in (B) in FIG. 4B shows a section cut along D-D section line in the upper left drawing. In the process shown here, regarding the electromagnetic coil 100A, the coil end regions 100ACE are bent toward the outer circumference side of the cylindrical region as shown in (A) in FIG. 4B, and, regarding the electromagnetic coil 100B, the coil end regions 100BCE are not bent as shown in (B) in FIG. 4B. Note that, in the process shown in (A) and (B) in FIG. 4B, the step of bending the electromagnetic coil 100A along the cylindrical region and the step of bending the coil end regions 100ACE toward the outer circumference side of the cylindrical region may be performed at the same time.

As shown in (A) in FIG. 4B, regarding the electromagnetic coil 100A, the whole is bent from the planar shape along the cylindrical surface, and the coil end regions of the electromagnetic coil 100A are bent outward from the cylindrical surface. On the other hand, as shown in (B) in FIG. 4B, regarding the electromagnetic coil 100B, the whole is bent from the planar shape along the cylindrical surface, but the coil end regions of the electromagnetic coil 100B are not bent outward from the cylindrical surface. Note that the electrical resistance does not change even when the shape is changed, and the electrical resistance of the electromagnetic coil 100A and the electrical resistance of the electromagnetic coil 100B take the same value. On the other hand, the electromagnetic coil 100A and the electromagnetic coil 100B have the same effective coil region shape, and different coil end region shapes. That is, of the inductances, the inductances caused by the effective coil regions are the same, however, the inductances caused by the coil end regions are different. In other words, the inductance of the electromagnetic coil 100A and the inductance of the electromagnetic coil 100B are slightly different. Generally, when the coil end regions are bent, the area s in the magnetic flux direction of the electromagnetic coil 100A becomes slightly smaller, and the inductance becomes slightly smaller. For example, the inductance L of a coil is expressed by the following equation.

$$L = \frac{k \times μ \times {n}^{2} \times s}{l}$$

Here, k is the Nagaoka coefficient, μ is permeability, n is the number of turns, s is a sectional area of the electromagnetic coil, and 1 is the length of the electromagnetic coil.

FIG. 4C illustrates explanatory diagrams (3) showing the formation step of the electromagnetic coil. In the process shown in FIG. 4C, insulating films 101 are formed on the surfaces of the electromagnetic coils 100A, 100B. The electromagnetic coil wires 105 (see FIG. 4A) forming the electromagnetic coils 100A, 100B have insulating coating (not shown). At the step shown in (A) in FIG. 4B, compression is applied while heating, and the insulating coating becomes thinner and the withstand voltage of the electromagnetic coil 100A or 100B becomes lower. Accordingly, the insulating films 101 are formed on the surfaces of the electromagnetic coils 100A, 100B, and thereby, the withstand voltages of the electromagnetic coils 100A, 100B are improved. Note that the electrical resistance of the conductor (wire) of the electromagnetic coil 100A or 100B is extremely small, and the voltage drop with respect to each turn is extremely small. Therefore, the voltages of the wire with respect to each turn is nearly the same voltage, and, even when the withstand voltage between the wires forming each turn is lower, a problem due to the leakage current is hard to occur. Thus, it is preferable to improve the space factor by thinning the coating of the electromagnetic coil wire 105, and further, improve the withstand voltages of the surfaces of the electromagnetic coils 100A, 100B by providing the insulating films 101 on the surfaces of the electromagnetic coils 100A, 100B.

FIG. 4D illustrates explanatory diagrams showing an overlapping step of the electromagnetic coils 100A, 100B. (A) in FIG. 4D schematically shows the step as seen from a direction along the rotation axis 230 (FIG. 1B). (B) in FIG. 4D schematically shows the step as seen from the outside in the radial direction of the rotation axis 230. Note that the electromagnetic coils 100A and 100B overlap, however, they are not superposed for visibility in (B) in FIG. 4D. At the step, the electromagnetic coil 100A is provided to overlap from the outside in the radial direction so that respective one effective coil regions of the two electromagnetic coils 100A may be located between the two effective coil regions of the electromagnetic coil 100B. It is preferable to position the electromagnetic coils 100A, 100B using a coil guide 270 (FIG. 2).

FIG. 4E illustrates explanatory diagrams showing an overlapping state of the electromagnetic coils 100A, 100B. (A) in FIG. 4E is a plan view as seen from the coil back yoke side and (B) in FIG. 4E is a perspective view schematically showing the state. Note that, in (A) in FIG. 4E, the coil back yoke 115 is shown and, in (B) in FIG. 4E, the coil back yoke 115 is omitted and only one electromagnetic coil 100A and two electromagnetic coils 100B are shown for visibility of the shapes of the electromagnetic coils 100A, 100B. Note that the actual electromagnetic coils 100A, 100B are provided along the side surface of the cylinder, and the coil end regions are curved surfaces, however, they are schematically shown as flat surfaces. As shown in (A) in FIG. 4E and (B) in FIG. 4E, the bundle of conductors of the effective coil regions of the two electromagnetic coils 100B are located between the two bundles of conductors of the effective coil regions of the electromagnetic coil 100A. Here, the electromagnetic coil 100 is formed by winding a conductor in plural turns (for example, M turns), and the bundle of conductors refers to the bundle of M conductors. Further, the bundle of conductors of the effective coil regions of the two electromagnetic coils 100A are located between the two bundles of conductors of the effective coil regions of the electromagnetic coil 100B (see (A) in FIG. 4E, only one electromagnetic coil 100A is shown in (B) in FIG. 4E), and the electromagnetic coils 100A, 100B do not interfere with each other. Furthermore, the coil end regions of the electromagnetic coil 100A are bent from the cylindrical region toward the coil back yoke 115 side (toward the outer circumference side of the cylindrical region), and do not interfere with the coil end regions of the electromagnetic coil 100B, which have not been bent from the cylindrical region. As described above, the effective coil regions of the electromagnetic coils 100A and the effective coil regions of the electromagnetic coils 100B are provided on the same cylindrical region, the bundles of conductors of two electromagnetic coils are provided between two bundles of conductors of one electromagnetic coil and the coil end regions of the electromagnetic coil 100A are bent toward the outer circumference side and the coil end regions of the electromagnetic coil 100B are not bent, and thereby, the electromagnetic coils 100A and 100B may be provided in the cylindrical region so as not to interfere with each other. In addition, in the embodiment, there is a relationship of L2˜2×φ1 between the thickness φ1 of the bundles of conductors of the electromagnetic coils 100A, 100B (the thickness in the direction along the cylindrical region in which the effective coil regions of the electromagnetic coils 100A are provided) and a distance between bundles of coils in the effective coil regions (a distance in the direction along the cylindrical region in which the effective coil regions of the electromagnetic coils 100A are provided) L2. That is, the cylindrical region in which the electromagnetic coils 100A, 100B are provided is nearly occupied by the bundles of conductors of the electromagnetic coils 100A, 100B, and thus, the space factor of the electromagnetic coils may be improved and the efficiency of the coreless motor 10 (FIGS. 1A and 1B) may be improved.

Next, an effect caused by the electrical resistances and the inductances of the electromagnetic coils 100A and 100B will be explained. As has been explained in FIG. 4B, the electrical resistance of the electromagnetic coil 100A and the electrical resistance of the electromagnetic coil 100B take the same value. Regarding the inductance without the coil back yoke 115, as shown in FIG. 4B, the inductances caused by the effective coil regions are the same, but the inductances caused by the coil end regions are different, and the inductance of the electromagnetic coil 100A and the inductance of the electromagnetic coil 100B are slightly different. However, like the embodiment, in the state in which the coil back yoke 115 and the electromagnetic coil 100A overlap, regarding the inductance of the electromagnetic coil 100A, the inductance in the part in which the coil back yoke 115 and the electromagnetic coil 100A overlap, i.e., in the effective coil region is predominant. The same applies to the electromagnetic coil 100B. Here, the effective coil region of the electromagnetic coil 100A and the effective coil region of the electromagnetic coil 100B have the same shape, and the inductance of the electromagnetic coil 100A and the inductance of the electromagnetic coil 100B takes nearly equal values. Therefore, the Lorentz force between the electromagnetic coil 100A and the permanent magnet 200 and the Lorentz force between the electromagnetic coil 100B and the permanent magnet 200 have the same magnitude and they are balanced, and thereby, the efficiency of the electric motor 10 may be improved.

FIG. 5 is an explanatory diagram schematically showing wiring of the electromagnetic coils in the first embodiment. As is clear from FIG. 5, the winding directions of the electromagnetic coils 100A are alternately clockwise and counter-clockwise. The same applies to the electromagnetic coil 100B.

As described above, the coreless motor 10 of the embodiment includes the permanent magnets 200, the two phases of coreless (air core) electromagnetic coils 100A, 100B, and the coil back yoke 115. The respective phases of electromagnetic coils 100A, 100B each has the effective coil region and the coil end regions. Further, the effective coil regions of the respective phases of electromagnetic coils 100A, 100B have the same shapes. The effective coil regions of the respective phases of electromagnetic coils 100A, 100B are provided on the cylindrical surface between the permanent magnets 200 and the coil back yoke 115. The coil end regions of the electromagnetic coil 100A are bent outward from the cylindrical surface. Further, the respective phases of electromagnetic coils 100A, 100B have the same electrical resistance value. Furthermore, the coil back yoke 115 covers the effective coil regions of the respective phases of electromagnetic coils 100A, 100B and does not cover the coil end regions, and thus, the inductances of the respective phases of electromagnetic coils 100A, 100B have substantially the same value. Therefore, the Lorentz force between the electromagnetic coil 100A and the permanent magnet 200 and the Lorentz force between the electromagnetic coil 100B and the permanent magnet 200 have the same magnitude and they are balanced, and thereby, the efficiency of the electric motor 10 may be improved.

In addition, as explained in FIGS. 4A to 4E, the respective phases of electromagnetic coils 100A, 100B are formed by bending the electromagnetic coils 100A, 100B having the same shape on the plane along the cylindrical surface and the coil end regions of the A-phase electromagnetic coil 100A outward of the cylindrical surface, and thereby, the electrical resistances of the respective phases of electromagnetic coils 100A, 100B may be easily set to the same.

Further, the distance L2 between the bundles of conductors forming the coils in the two effective coil regions of the respective phases of electromagnetic coils 100A, 100B is twice the thickness φ1 of the bundles of conductor coils in the effective coil regions of the electromagnetic coils 100A, 100B, and thus, by efficiently providing two phases of coils between each other, the space factor of the electromagnetic coils 100A, 100B may be made larger and the efficiency of the coreless motor 10 may be improved.

### Second Embodiment

As described above, in the first embodiment, the space factor of the electromagnetic coils 100A, 100B may be made larger and the efficiency of the coreless motor 10 may be improved. However, the wire connection of the electromagnetic coils 100 is slightly complex, and the manufacturing process may be slightly complex because the electromagnetic coils 100A, 100B are combined and wire-connected one by one at manufacturing. In the second embodiment, further improvement in the space factor of the electromagnetic coils 100A, 100B and facilitation of wire connection may be realized and simplification of the manufacturing process may be realized.

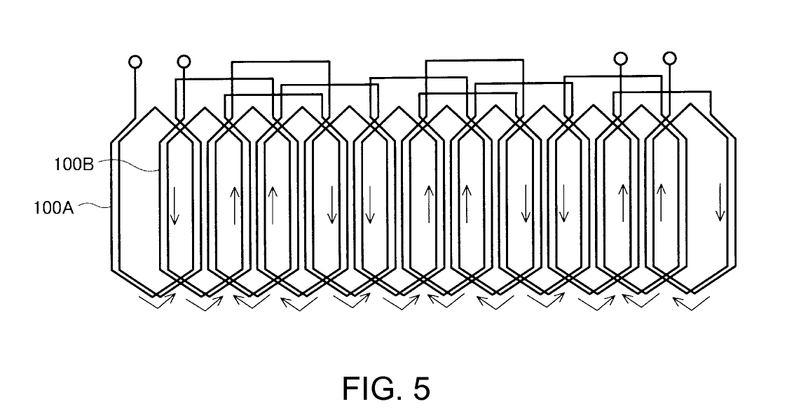

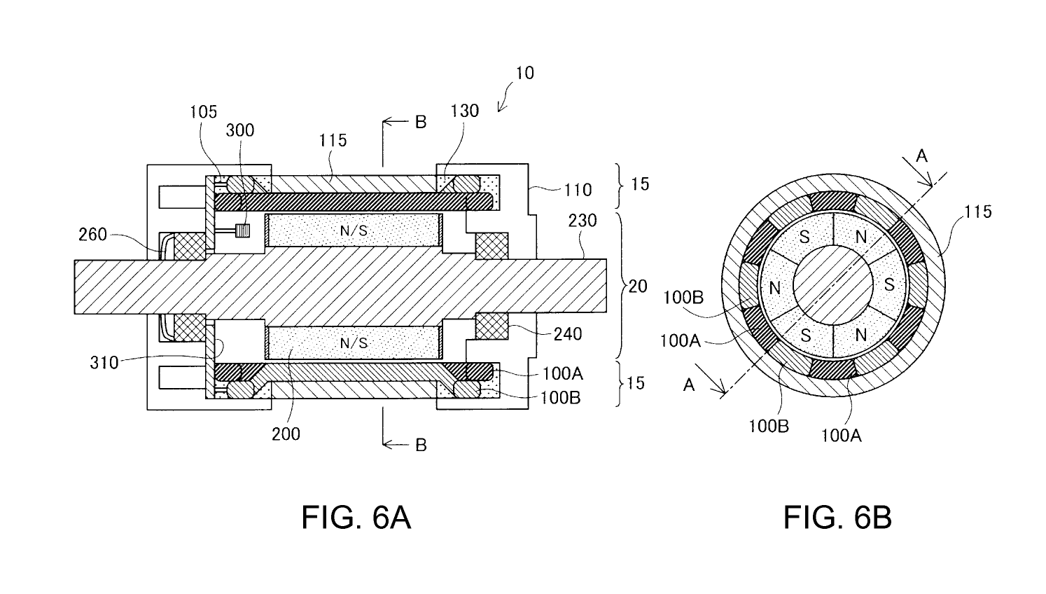

FIGS. 6A and 6B are explanatory diagrams showing the second embodiment. FIG. 6A is a diagram schematically showing a section of the coreless motor 10 cut along a section line (A-A in FIG. 6B) in parallel to the rotation axis 230 as seen from a direction perpendicular to the section, and FIG. 6B is a diagram schematically showing a section of the coreless motor 10 cut along a section line (B-B in FIG. 6A) perpendicular to the rotation axis 230 as seen from a direction perpendicular to the section. In comparison with the first embodiment, in the second embodiment, the number of the electromagnetic coils 100A, 100B is a half. Further, in the first embodiment, there are the parts in which the same phase of electromagnetic coils contact each other as shown by the mark X in FIG. 3A, however, the second embodiment is different in that there are no parts in which the same phase of electromagnetic coils contact each other. That is, the first and second embodiments are different in winding of the electromagnetic coils 100A, 100B. Note that, in the first embodiment, the coil end regions of the electromagnetic coil 100A are bent outward (in the radial direction) and, in the second embodiment, the coil end regions of the electromagnetic coil 100B are bent outward (in the radial direction). The phases of the bent electromagnetic coils 100 are different between the A phase and the B phase. However, in the coreless motor 10, generally, the A-phase electromagnetic coil 100A and the B-phase electromagnetic coil 100B may be exchanged.

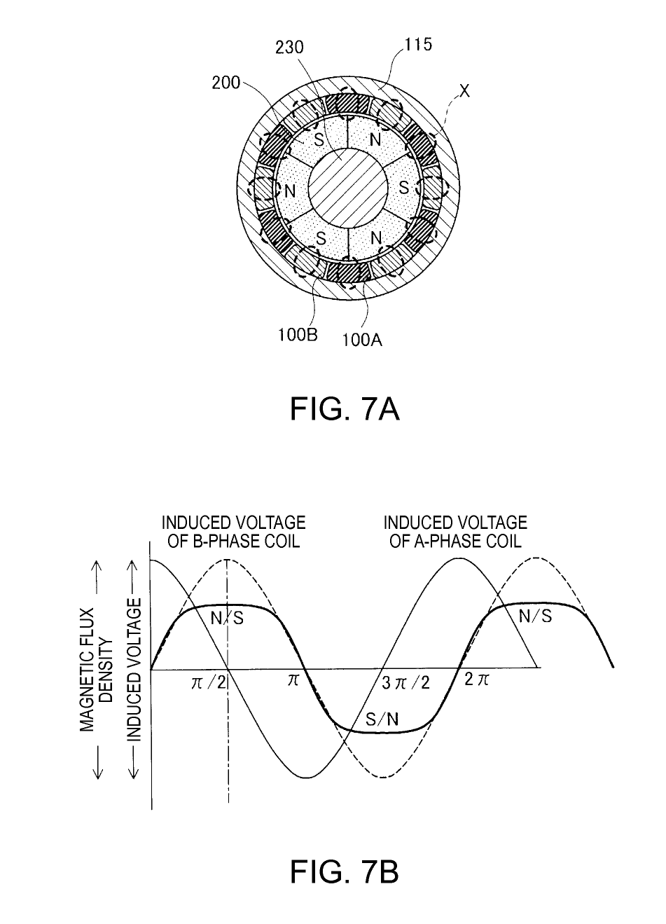

FIG. 7A is a diagram showing locations with marks X by broken lines in FIG. 6B corresponding to the locations with the marks X in FIG. 3A. In FIG. 3A, the locations with the marks X are the locations where the two same phases of electromagnetic coils (for example, the electromagnetic coils 100A and 100A) are adjacent, however, in FIG. 7A, the locations with the marks X are at the centers of the bundles of coils of the electromagnetic coils 100A, 100B. That is, in the example shown in FIG. 7A, the location with the mark X is one electromagnetic coil and no gap is produced. That is, in the second embodiment, because there is no gap, the space factor of the electromagnetic coils 100 in the regions where the maximum force F is generated on the electrical angle may be further improved than in the first embodiment.

FIG. 7B is a graph showing an electrical angle of a coreless motor, induced voltages of electromagnetic coils, and magnetic flux density sensed by a magnetic sensor 300 (FIG. 6A). In FIG. 7B, the phase when the boundary part between the two permanent magnets 200 coincides with the boundary between the two electromagnetic coils 100A, 100B is set to zero, and the electrical angle when the boundary part between the two permanent magnets 200 coincides with the center of the bundles of the coils of the respective electromagnetic coils 100A, 100B (the state in FIG. 7A) is set to π/2. The magnetic flux density sensed by the magnetic sensor 300 becomes the maximum when the electrical angle is π/2 (3π/2), and becomes the minimum when the electrical angle is 0 (π, 2π). Further, the induced voltage of the electromagnetic coil 100B becomes the maximum when the electrical angle is π/2 (3π/2), and becomes zero when the electrical angle is 0 (π, 2π). On the other hand, the induced voltage of the electromagnetic coil 100A becomes zero when the electrical angle is π/2 (3π/2), and becomes the maximum when the electrical angle is 0 (π, 2π).

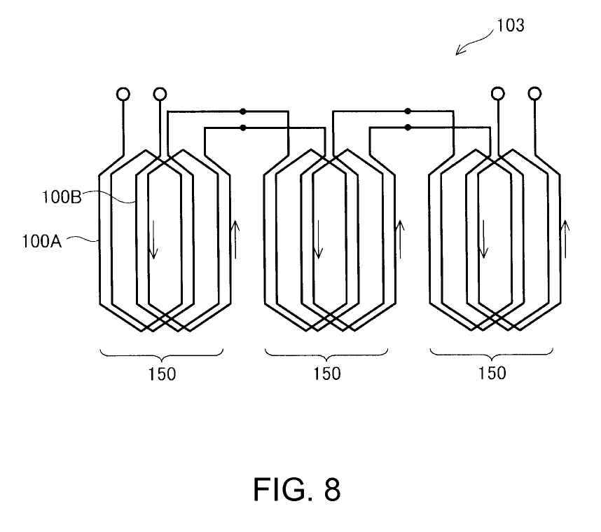

FIG. 8 is an explanatory diagram schematically showing wiring of the electromagnetic coils in the second embodiment. As is clear from the comparison with FIG. 5 (first embodiment), the wire connection of the electromagnetic coils 100A, 100B in the second embodiment is simpler than that of the first embodiment. In other words, it is difficult to divide the electromagnetic coils 100A, 100B into plural coil assemblies in the first embodiment, however, the electromagnetic coils 100A, 100B may be easily divided into plural (three in the embodiment) electromagnetic coil sub-assemblies 150 in the second embodiment. That is, in the second embodiment, an electromagnetic coil assembly 103 may be easily formed by creating the electromagnetic coil sub-assemblies 150 and combining the electromagnetic coil sub-assemblies 150. Note that, in the embodiment, the cylindrical combination of the electromagnetic coils 100A, 100B is referred to as “electromagnetic coil assembly 103”. In the manufacturing process, which will be described later, the electromagnetic coils 100A and 100B are molded with the coil back yoke 115 by a resin 130. The electromagnetic coils 100A and 100B molded with the coil back yoke 115 by the resin 130 is referred to as “electromagnetic coil assembly with coil back yoke”.

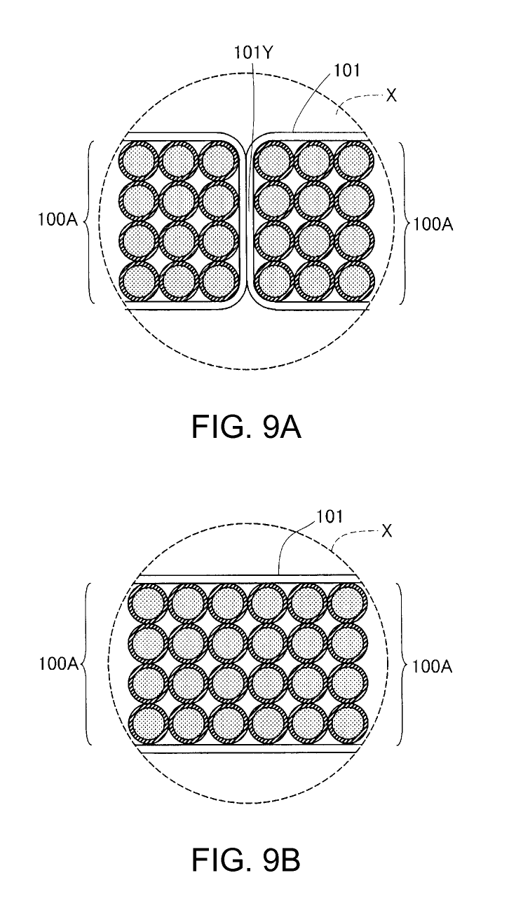

FIG. 9A is an enlarged explanatory diagram showing the part with the mark X in FIG. 3A. FIG. 9B is an enlarged explanatory diagram showing the part with the mark X in FIG. 7A. The electromagnetic coil 100A has the insulating thin film layer 101 on the outer periphery. In the first embodiment shown in FIG. 9A, an insulating thin film layer 101Y exists in the part in which the two electromagnetic coils 100A, 100B are in contact. On the other hand, in the second embodiment shown in FIG. 9B, the part with the mark X is formed by one electromagnetic coil, and the insulating thin film layer 101Y is not formed in the part in which the insulating thin film layer 101Y exists in FIG. 9A. The insulating thin film layer 101Y is not a conductor, and reduces the space factor. Conversely, the space factor may be further improved in the second embodiment than the first embodiment.

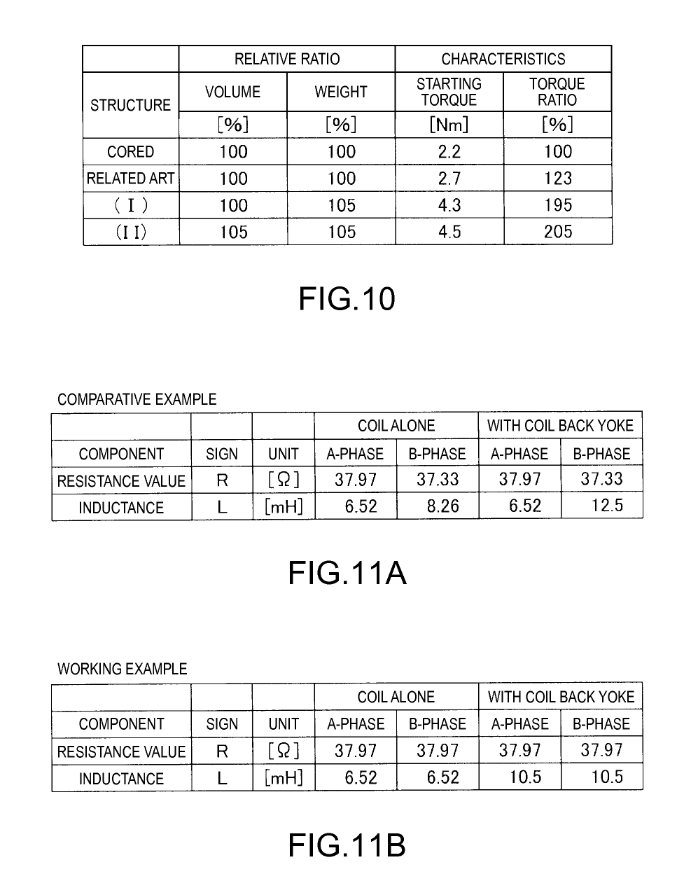

FIG. 10 is an explanatory diagram for comparison between characteristics of the coreless motors of the first and second embodiments and characteristics of a cored motor and a coreless motor in related art. Here, in the drawing, (I) shows the first embodiment and (II) shows the second embodiment. Further, the coreless motor in related art refers to a motor in which A-phase electromagnetic coils 100A are provided on the inner cylindrical surface (near the permanent magnets 200) and B-phase electromagnetic coils 100B are provided on the outer cylindrical surface (near the coil back yoke 115 ). Note that the cylindrical surface on which the electromagnetic coils 100A are provided and the cylindrical surface on which the electromagnetic coils 100B are provided are different. In comparison with the cored motor and the coreless motor in related art having nearly equal volumes and weights, the starting torque is larger both in the first and second embodiments. Here, with the starting torque of the cored motor as 100%, the torque is 195% in the first embodiment and 205% in the second embodiment, about twice. Further, in comparison between the first and second embodiments, the starting torque of the second embodiment is slightly larger than the starting torque of the first embodiment. This may be because no insulating thin film layer 101Y exists in the second embodiment and the space factor is slightly higher than that of the first embodiment as shown in FIGS. 9A and 9B.

FIG. 11A is an explanatory diagram showing electrical resistances and inductances of electromagnetic coils in the coreless motor in a comparative example. In the coreless motor in the comparative example (related art), the electromagnetic coils 100A, 100B are provided on the different cylindrical surfaces, and it is difficult to make all electrical characteristics of the electromagnetic coils 100A, 100B equal. For example, even when the electrical resistance of the electromagnetic coil 100A and the electrical resistance of the electromagnetic coil 100B are made nearly equal as shown in FIG. 11A, the inductances of the electromagnetic coils 100A, 100B are different because the distance between the electromagnetic coil 100A and the coil back yoke 115 and the distance between the electromagnetic coil 100B and the coil back yoke 115 are different. For example, when the electromagnetic coil 100B is nearer the coil back yoke 115 than the electromagnetic coil 100A, the inductance of the electromagnetic coil 100B is larger.

FIG. 11B is an explanatory diagram showing electrical resistances and inductances in the coreless motor of the first embodiment. As is clear from FIG. 11B, the electromagnetic coils 100A, 100B are equivalent with respect to the electrical characteristics (electrical resistance, inductance). With the coil back yoke 115, the effective coil regions predominantly contribute to the inductances of the electromagnetic coils 100A, 100B. Further, in the first embodiment, the shapes of the effective coil regions of the electromagnetic coils 100A, 100B are the same, and the distance between the effective coil region of the electromagnetic coil 100A and the coil back yoke 115 and the distance between the effective coil region of the electromagnetic coil 100B and the coil back yoke 115 are equal. Accordingly, the values of the electrical resistances and the inductances of the electromagnetic coils 100A, 100B may be made equal and they may be well balanced. Note that the electrical resistances of the electromagnetic coils 100A, 100B may be easily made equal by making the thicknesses and the lengths of the conductors forming the electromagnetic coils 100A, 100B equal.

As below, manufacturing of an electromagnetic coil assembly with coil back yoke 104 of the coreless motor 10 will be explained. Here, an assembly obtained by encasing the two electromagnetic coils 100A, 100B and the coil back yoke 115 with the resin 130 is referred to as “electromagnetic coil assembly with coil back yoke 104”. The electromagnetic coil assembly with coil back yoke 104 includes plural coil assemblies. First, a process of manufacturing the electromagnetic coil sub-assemblies 150 will be explained, and then, a process of manufacturing the electromagnetic coil assembly with coil back yoke 104 from the electromagnetic coil sub-assemblies 150 will be explained.

Manufacturing Process of Coil Assembly

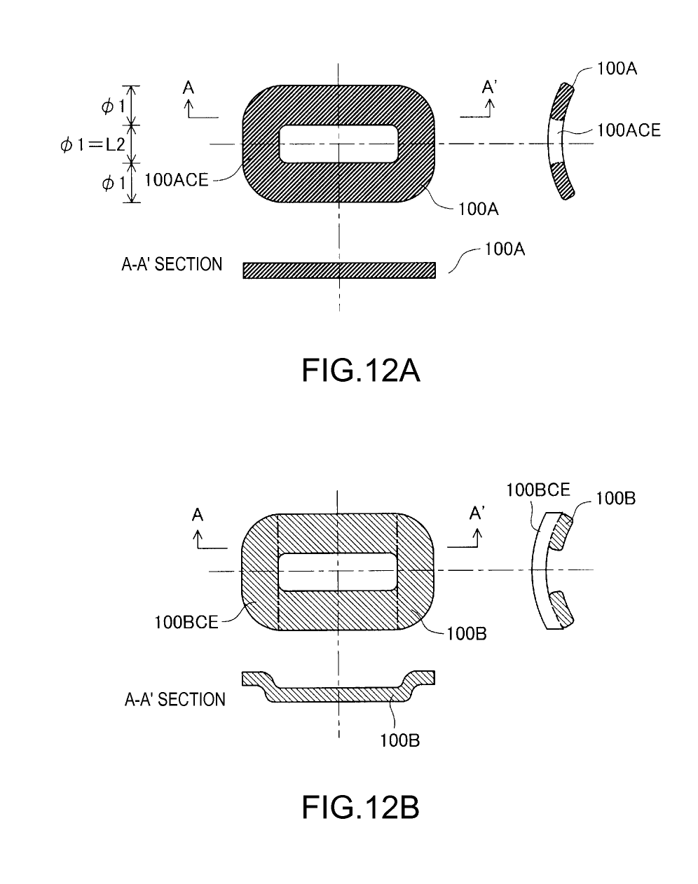

FIG. 12A is an explanatory diagram for explanation of a forming step of the electromagnetic coil 100A. The electromagnetic coil 100A before forming may be formed in the same manner as that shown in FIG. 4A. Note that the ratio of the thickness of the bundle of conductors of the electromagnetic coil 100A to the distance between the effective coil regions is different from that of the first embodiment. That is, in the first embodiment, the ratio of the thickness φ1 of the bundle of conductors of the electromagnetic coil 100A to the distance L2 between the effective coil regions is about 1:2, and, in the second embodiment, the ratio of the thickness φ1 to the distance L2 is about 1:1. A conductor with insulating film forming the electromagnetic coil 100A is wound in a rectangular shape with rounded corners, pressurized, and formed in a shape having a partial shape of the cylindrical region. In this regard, the electromagnetic coil 100A wound in the rectangular shape with rounded corners in the radial direction of the cylindrical region is pressurized so that the thickness of the insulating film of the conductor may be from 30% to 100% or from 20% to 100% before pressurization. Note that, as the thickness of the insulating film is thinner, the withstand voltage between the conductors becomes lower, however, there is no problem of leakage current between the conductors within the same electromagnetic coil because the potentials of the conductors within the same electromagnetic coil are equal and the sufficient withstand voltage is kept even when the withstand voltage between the conductors becomes lower.

FIG. 12B is an explanatory diagram for explanation of a forming step of the electromagnetic coil 100B. The shape of the electromagnetic coil 100A before forming is the same as that of the electromagnetic coil 100A, and the electromagnetic coil 100B before forming may be formed in the same manner as that of the electromagnetic coil 100A. The forming step of the electromagnetic coil 100B is the same as the forming step of the electromagnetic coil 100A. However, the forming of the electromagnetic coil 100B is the same as the forming of the electromagnetic coil 100A except that coil end regions 100BCE are bent outward from the cylindrical surface. Note that the shape of the electromagnetic coil 100B before the coil end regions 100BCE are bent outward from the cylindrical surface is the same as the shape of the electromagnetic coil 100A.

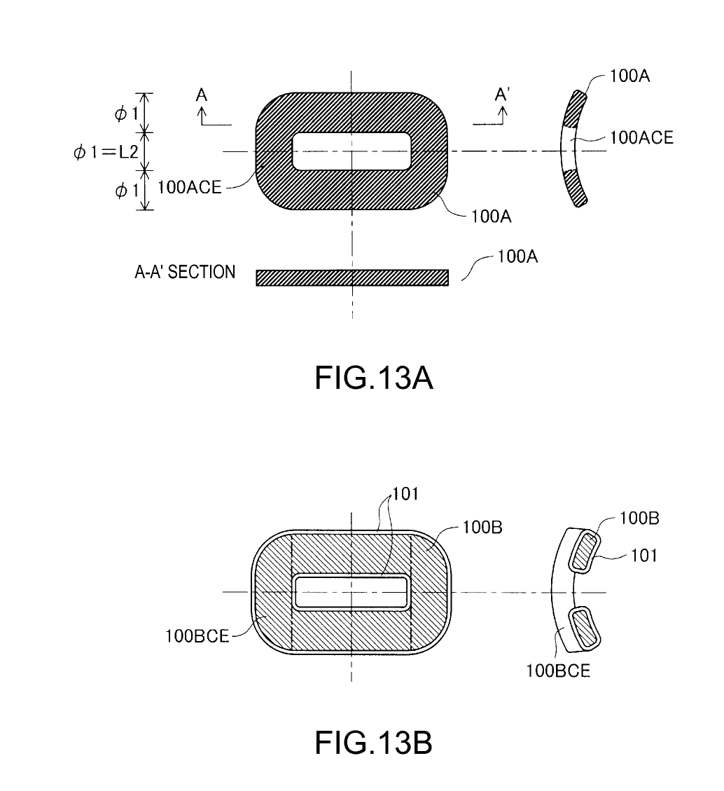

FIG. 13A is an explanatory diagram showing an insulating film layer formation step on the electromagnetic coil 100A. FIG. 13B is an explanatory diagram showing an insulating film layer formation step on the electromagnetic coil 100B. As described above, the potentials are respectively equal within the electromagnetic coil 100A or the electromagnetic coil 100B, and the thickness of the insulating films of the conductors are thinner and there is no problem of leakage current between the conductors within the same electromagnetic coil even when the withstand voltage between the conductors is lower. However, when the coils are assembled in the coreless motor 10, the electromagnetic coils 100A and 100B are brought into contact, and it is preferable to improve the withstand voltage between the electromagnetic coils 100A, 100B in consideration of the higher withstand voltage (1.5 [kV] or higher) characteristics between the electromagnetic coils 100A and 100B and the coil back yoke 115. In the embodiment, the insulating thin film layers 101 are formed on the entire range of the electromagnetic coils 100A, 100B, and the withstand voltage is secured. As a material of the insulating thin film layers 101, for example, a titanium oxide-containing silane coupling agent, parylene, epoxy, silicone, or urethane may be used.

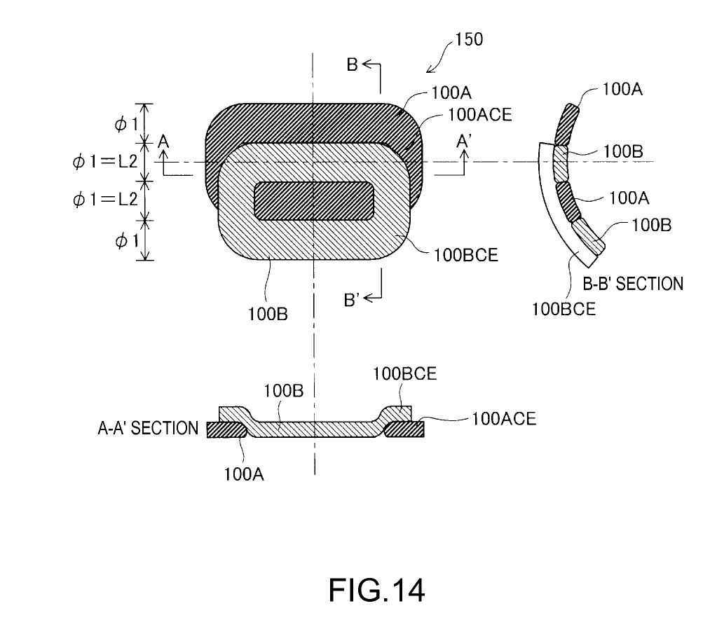

FIG. 14 is an explanatory diagram showing an assembly step of the electromagnetic coils 100A and 100B. Note that, in FIG. 14, the insulating thin film layers 101 (FIGS. 13A, 13B) are omitted. The electromagnetic coil sub-assembly 150 is formed by fitting the electromagnetic coil 100B so that the effective coil regions of the electromagnetic coil 100B may be fitted from the outer circumference side in the radial direction of the cylindrical region in which the electromagnetic coil 100A is provided into between the two effective coil regions at the center of the electromagnetic coil 100A. The electromagnetic coil sub-assemblies 150 form a part of the cylindrical surface of the electromagnetic coil 100. Further, the coil end regions 100BCE of the electromagnetic coil 100B are bent toward the outer circumference side in the radial direction of the cylindrical region in which the electromagnetic coil 100B is provided in the part near the bottom surface of the cylindrical region. Furthermore, a part of the coil end region 100ACE of the electromagnetic coil 100A and apart of the coil end region 100BCE of the electromagnetic coil 100B overlap.

Manufacturing of Electromagnetic Coil Assembly with Coil Back Yoke (First Method)

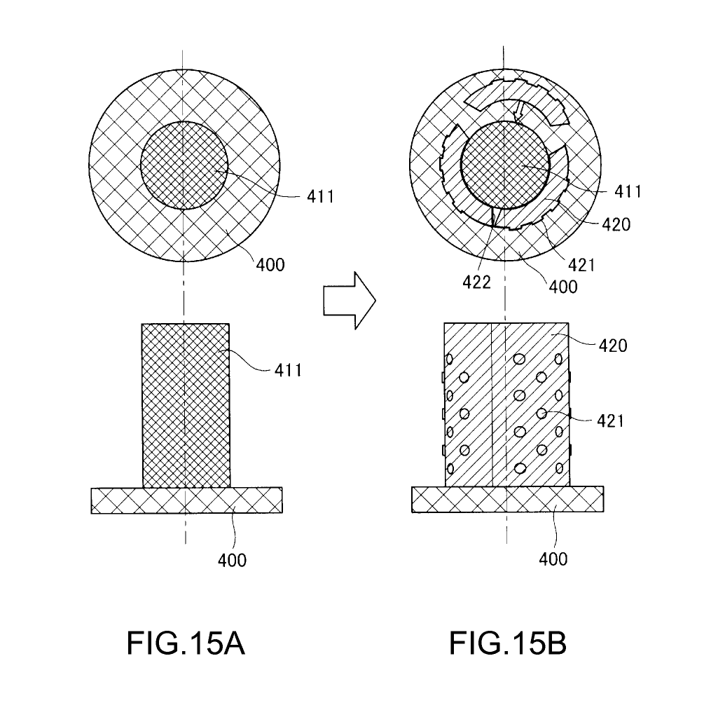

FIGS. 15A and 15B are explanatory diagrams (1) showing a part of a formation step of an electromagnetic coil assembly. At the step shown in FIG. 15A, a base 400 having a core pin 411 is prepared. The base 400 has a nearly disc shape. The core pin 411 is a member having a nearly cylindrical shape, and placed at the center of the base 400. The base 400 and the core pin 411 may be integrally formed. At the step shown in FIG. 15B, three inner dies 420 are placed in the outer circumference part of the core pin 411. The three inner dies 420 form a nearly cylindrical shape. The inner die 420 has projections 421 on the outer surface. The height of the projection 421 is preferably from 10 to 20 μm and may be from 10 to 100 μm. Further, in the inner die 420, inner circumference/(radius of curvature of inner circumference)<outer circumference/(radius of curvature of outer circumference). Accordingly, when the inner dies 420 are placed in the outer circumference part of the core pin 411, wedge-shaped spaces 422 are formed in the joint parts between the two inner dies 420. The wedge-shaped spaces 422 facilitate detachment by moving the inner dies 420 toward the center after the removal of the core pin 411. Note that, in the embodiment, the inner dies 420 have the three-split configuration, however, two-split or four-split configuration other than the three-split configuration may be employed.

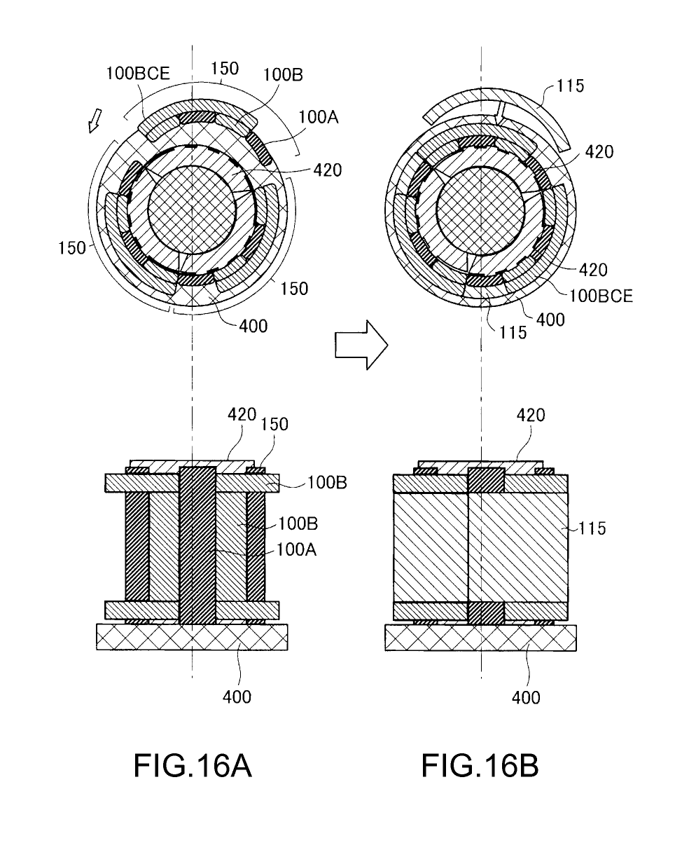

FIGS. 16A and 16B are explanatory diagrams (2) showing a part of the formation step of the electromagnetic coil assembly. At the step shown in FIG. 16A, the electromagnetic coil sub-assemblies 150 are placed outside of the inner dies 420. In the embodiment, three electromagnetic coil sub-assemblies 150 form a nearly cylindrical shape. At the step shown in FIG. 16B, the coil back yoke 115 is placed outside of the effective coil regions of the electromagnetic coils 100A, 100B. In the embodiment, the coil back yoke 115 has a three-split configuration. The number of splits may be two or more.

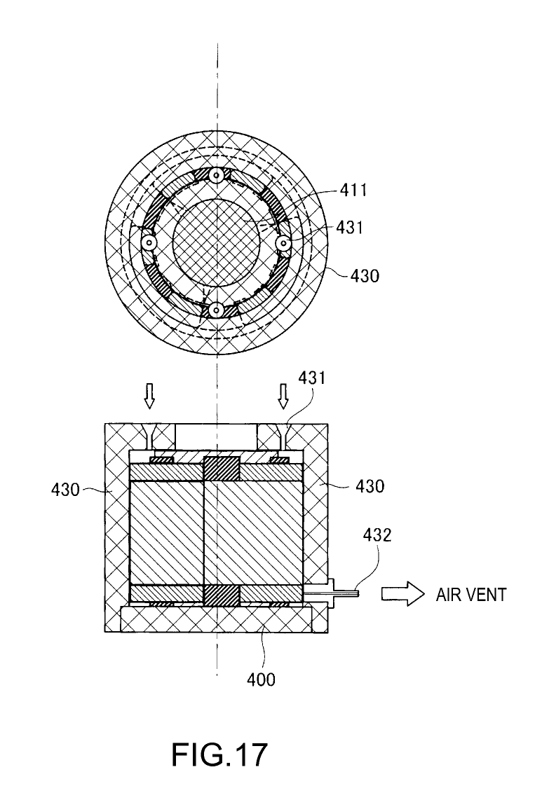

FIG. 17 is an explanatory diagram (3) showing a part of formation step of the electromagnetic coil assembly. At the step shown in FIG. 17, an outer die 430 is placed outside of the coil back yoke 115. The outer die 430 includes resin injection holes 431 and an air vent port 432. Note that, in FIG. 17, illustration of the air vent port 432 is omitted in the upper plan view.

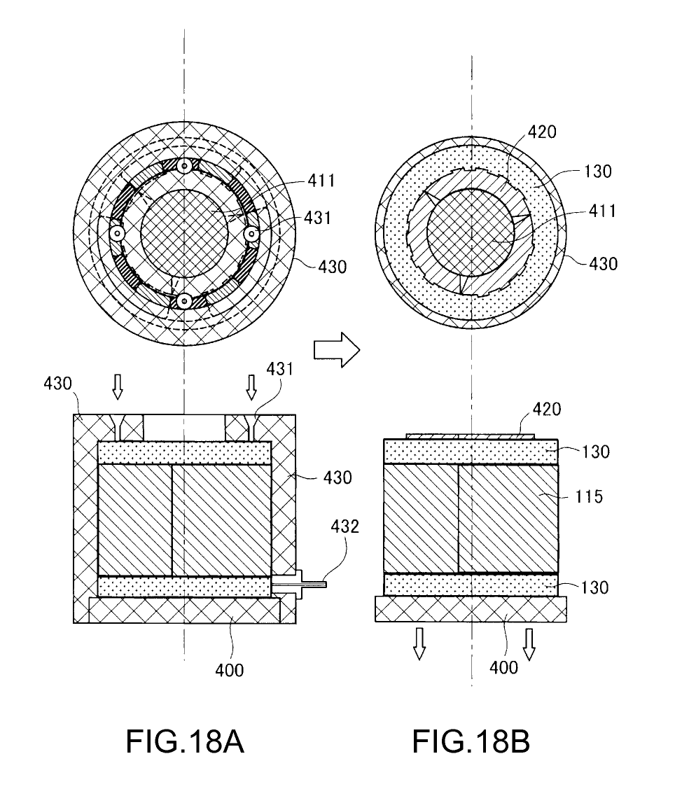

FIGS. 18A and 18B are explanatory diagrams (4) showing a part of the formation step of the electromagnetic coil assembly. At the step shown in FIG. 18A, the resin 130 at the high temperature is injected from the resin injection holes 431 of the high-temperature die, and then, the molding die is defoamed using a vacuum pump. After the resin 130 is solidified, the outer die 430 is detached. FIG. 18B shows a state in which the outer die 430 has been detached. Then, from the state shown in FIG. 18B, the base 400 and the core pin 411 are removed.

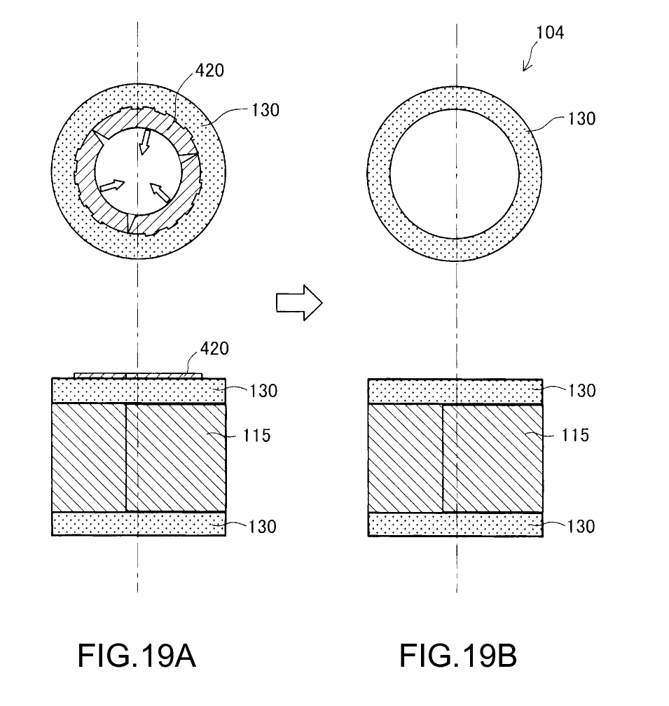

FIGS. 19A and 19B are explanatory diagrams (5) showing a part of the formation step of the electromagnetic coil assembly. FIG. 19A shows a state in which the base 400 and the core pin 411 have been removed. From the state shown in FIG. 19A, the three inner dies 420 are respectively moved and detached in the direction in which the core pin 411 has been, and thereby, the electromagnetic coil assembly 103 is formed. FIG. 19B shows a state in which the inner dies 420 have been detached. As described above, in the process shown in FIGS. 15A to 19B, the electromagnetic coil assembly with coil back yoke 104 may be formed from the electromagnetic coil sub-assemblies 150.

Manufacturing of Electromagnetic Coil Assembly with Coil Back Yoke (Second Method)

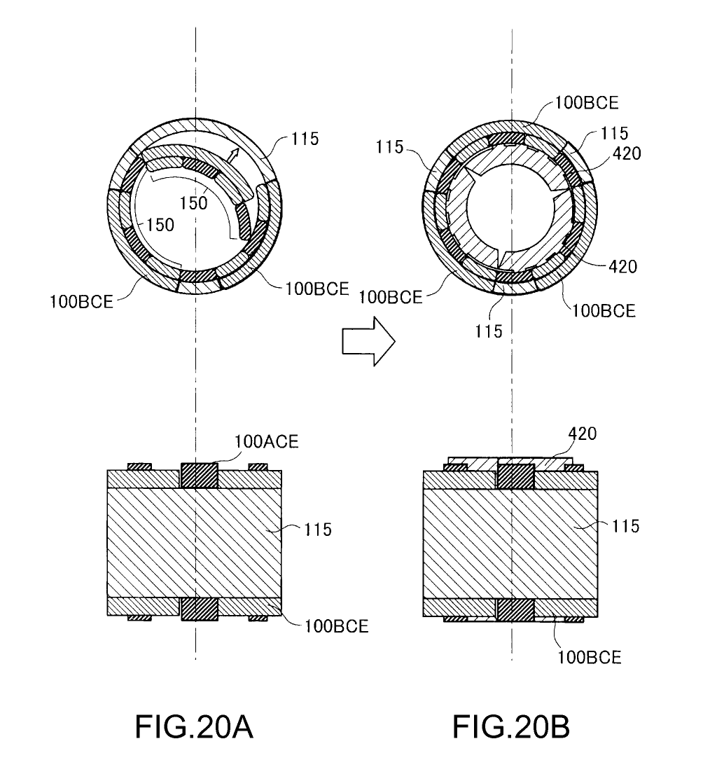

FIGS. 20A and 20B are explanatory diagrams (1) showing an example when the formation of the electromagnetic coil assembly is performed in another process. In the process that has been explained, the electromagnetic coil sub-assemblies 150 are combined, and then, the coil back yoke 115 is assembled, however, this process is different in that cylindrical the coil back yoke 115 is first prepared and the electromagnetic coil sub-assemblies 150 are assembled inside of the cylinder of the coil back yoke 115.

At the step shown in FIG. 20A, the electromagnetic coil sub-assemblies 150 are inserted inside of the cylinder of the coil back yoke 115 and fitted in the inner surface of the cylinder of the coil back yoke 115. In this regard, the electromagnetic coil sub-assemblies 150 are placed so that the coil back yoke 115 may be fitted between the two coil end regions 100BCE of the electromagnetic coil 100B of the electromagnetic coil sub-assemblies 150. Then, at the step shown in FIG. 20B, the three-split inner dies 420 are placed inside of the electromagnetic coil sub-assemblies 150.

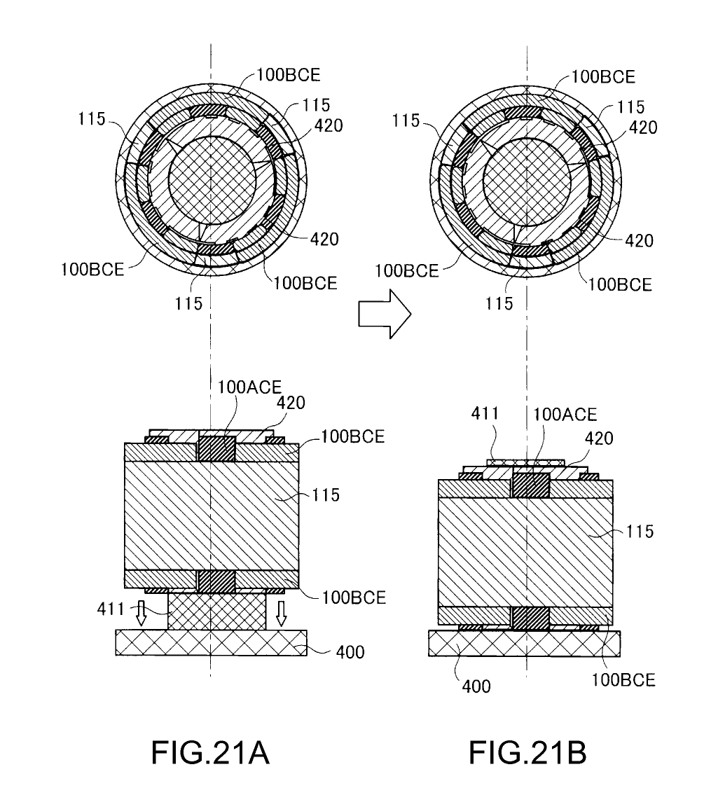

FIGS. 21A and 21B are explanatory diagrams (2) showing the example when the formation of the electromagnetic coil assembly is performed in the other process. At the step shown in FIG. 21A, the core pin 411 is inserted inside of the inner dies 420. Note that the base 400 is provided at one end of the core pin 411. FIG. 21B is an explanatory diagram showing a state in which the core pin 411 has been inserted.

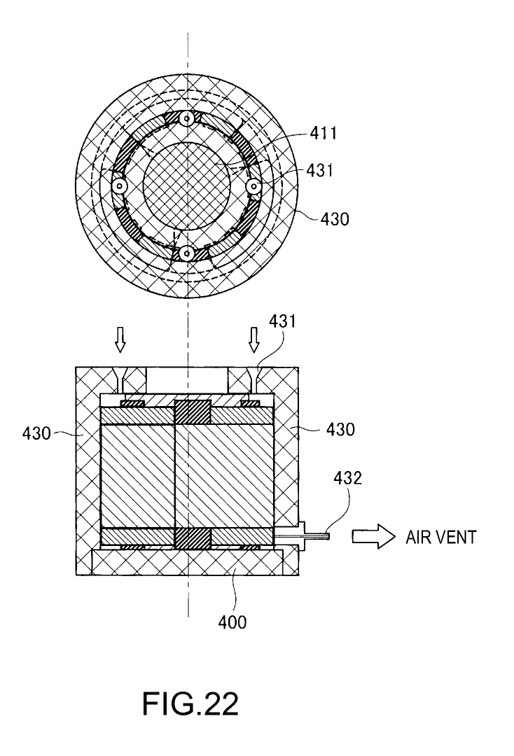

FIG. 22 is an explanatory diagram (3) showing the example when the formation of the electromagnetic coil assembly is performed in the other process. FIG. 22 is the same diagram as FIG. 17, and the outer die 430 including the resin injection holes 431 and the air vent port 432 is placed outside of the coil back yoke 115.

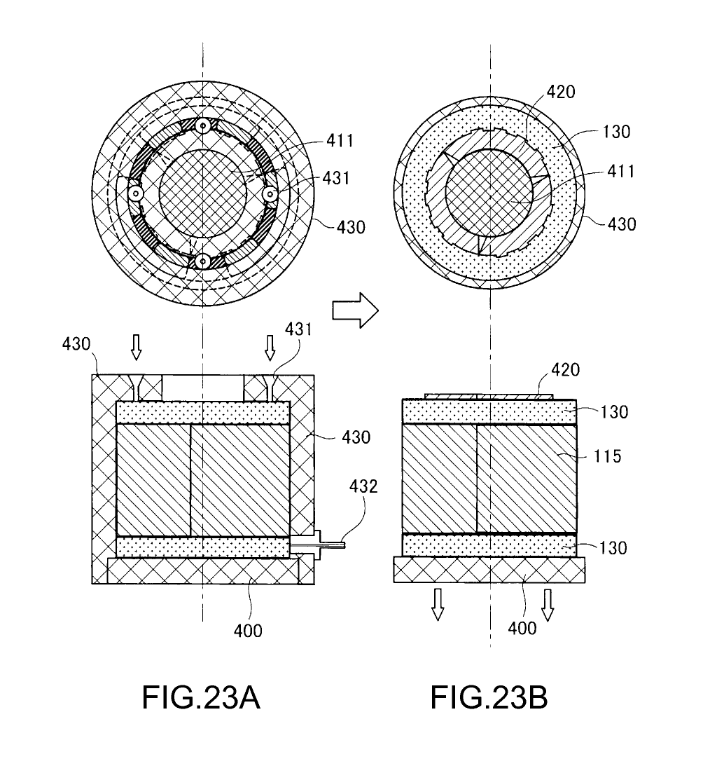

FIGS. 23A and 23B are explanatory diagrams (4) showing the example when the formation of the electromagnetic coil assembly is performed in the other process. FIGS. 23A and 23B are the same diagrams as FIGS. 18A and 18B. At the step shown in FIG. 23A, the resin 130 at the high temperature is injected from the resin injection holes 431 of the high-temperature die, and then, the molding die is defoamed using the vacuum pump. After the resin 130 is solidified, the outer die 430 is detached. FIG. 23B shows a state in which the outer die 430 has been detached. Then, from the state shown in FIG. 23B, the base 400 and the core pin 411 are removed.

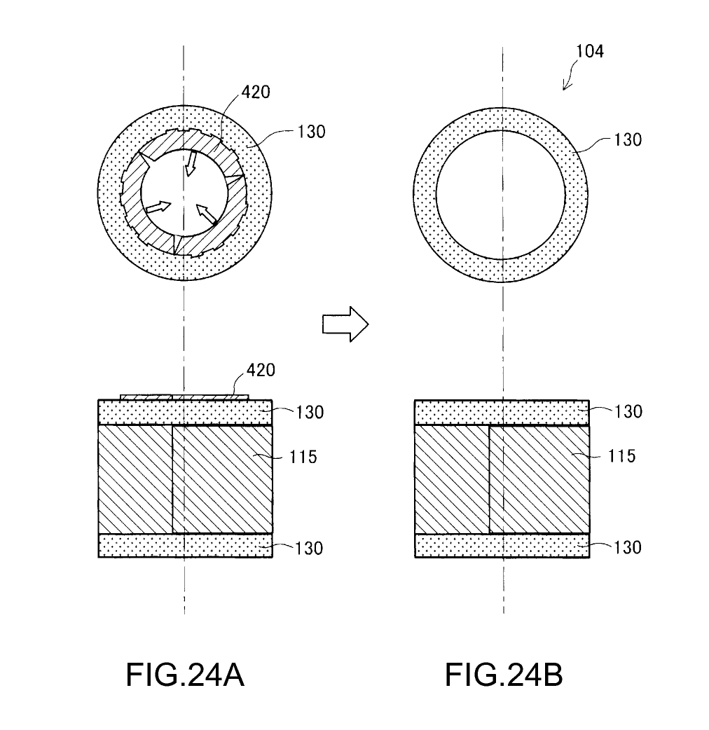

FIGS. 24A and 24B are explanatory diagrams (5) showing the example when the formation step of the electromagnetic coil assembly is performed in the other process. FIGS. 24A and 24B are the same diagrams as FIGS. 19A and 19B. FIG. 24A shows a state in which the base 400 and the core pin 411 have been removed. From the state shown in FIG. 24A, the three inner dies 420 are respectively moved and detached in the direction in which the core pin 411 has been, and thereby, the electromagnetic coil assembly 103 is formed. FIG. 24B shows a state in which the inner dies 420 have been detached. As described above, also, in the process shown in FIGS. 20A to 24B, the electromagnetic coil assembly with coil back yoke 104 maybe formed from the electromagnetic coil sub-assemblies 150. Note that the process is different in that, when the electromagnetic coil assembly with coil back yoke 104 is manufactured in the process shown in FIGS. 15A to 19B, the coil back yoke 115 has the split structure, however, when the electromagnetic coil assembly with coil back yoke 104 is manufactured in the process shown in FIGS. 20A to 24B, it is not necessary that the coil back yoke 115 has the split structure.

Manufacturing of Electromagnetic Coil Assembly with Coil Back Yoke (Third Method)

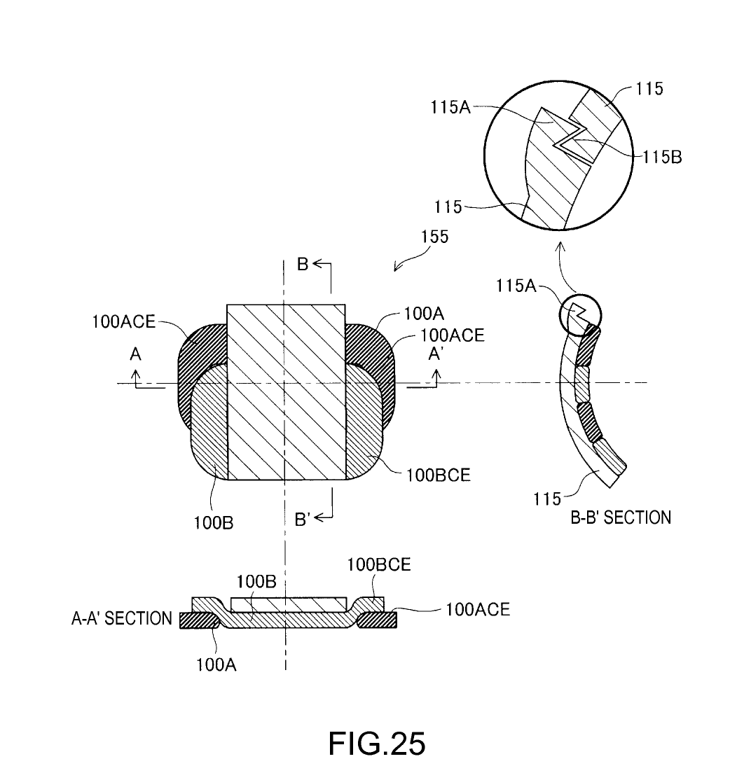

FIG. 25 is an explanatory diagram showing an electromagnetic coil sub-assembly 155 when the formation step of the electromagnetic coil assembly is performed in yet another process. The electromagnetic coil sub-assembly with coil back yoke 155 includes the coil back yoke 115 in addition to the electromagnetic coils 100A and 100B. The electromagnetic coil sub-assembly with coil back yoke 155 may be easily formed by joining the electromagnetic coil sub-assemblies 150 and the coil back yoke 115. Note that the joint between the electromagnetic coil sub-assemblies 150 and the coil back yoke 115 may not be so strong because they are integrated by molding using the resin 130 at the subsequent step. The coil back yoke 115 is placed to overlap with the effective coil regions of the electromagnetic coils 100A, 100B. The coil end regions 100ACE, 100BCE of the electromagnetic coils 100A, 100B do not overlap with the coil back yoke 115. A convex portion 115A is formed at one end in the rotation direction of the coil back yoke 115 and a concave portion 115B is formed at the other end. The convex portion 115A of the coil back yoke 115 is caught in the concave portion 115B of the adjacent coil back yoke 115, and thereby, may strongly engage with the coil back yoke 115.

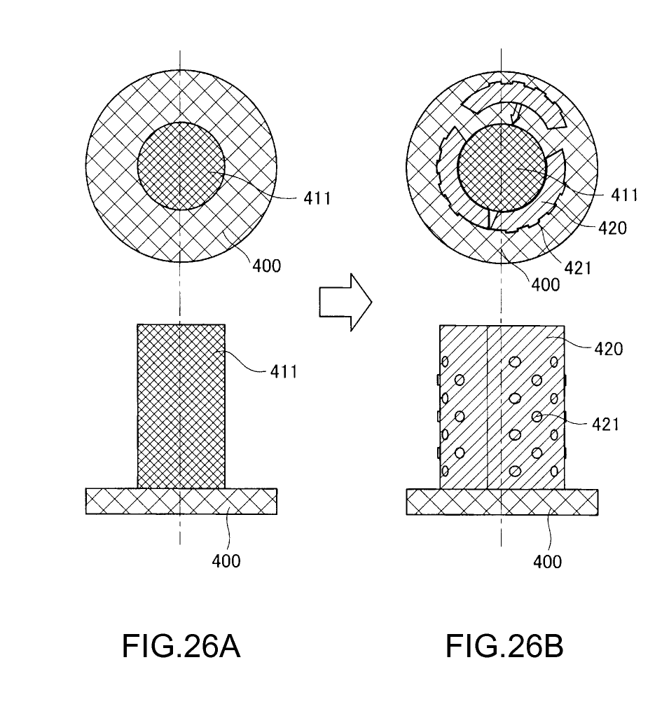

FIGS. 26A and 26B are explanatory diagrams (1) showing an example when the formation of the electromagnetic coil assembly is performed in yet another process. FIGS. 26A and 26B are the same as FIGS. 15A and 15B and the steps performed in FIGS. 26A and 26B are the same as the steps performed in FIGS. 15A and 15B, and their explanation will be omitted.

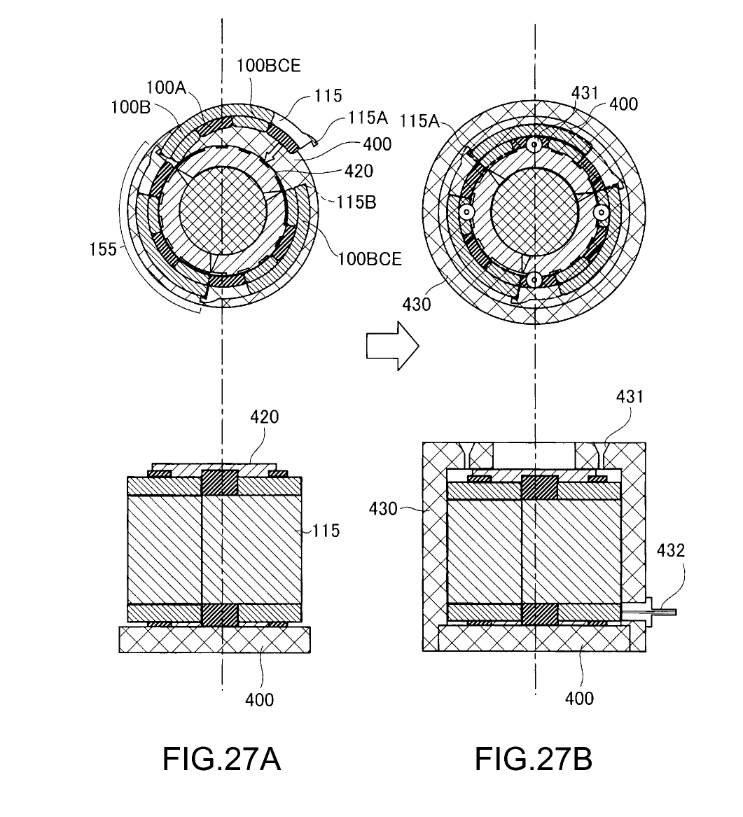

FIGS. 27A and 27B are explanatory diagrams (2) showing the example when the formation of the electromagnetic coil assembly is performed in the yet other process. At the step shown in FIG. 27A, with the convex portions 115A of the coil back yokes 115 engaged with the concave portion 115B (behind the coil end region 100BCE of the electromagnetic coil 100B in the drawing), the electromagnetic coil sub-assemblies with coil back yoke 155 are placed around the inner dies 420. FIG. 27B is an explanatory diagram showing a state in which, after placement of the electromagnetic coil sub-assemblies 155, the outer die 430 is further placed. In FIG. 27B, the parts of the convex portions 115A protrude, but except that, FIG. 27B is the same as FIG. 17.

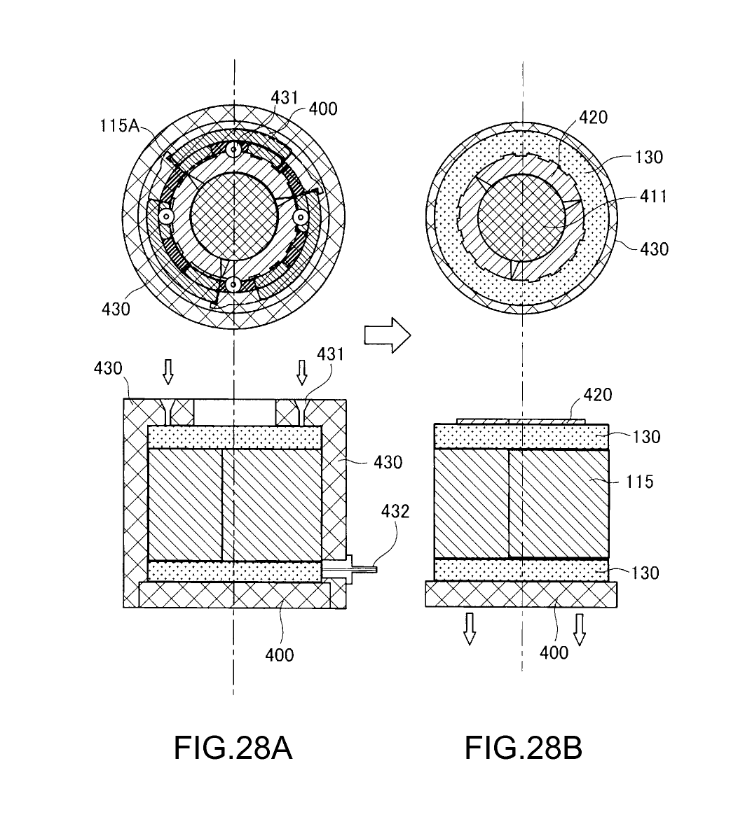

FIGS. 28A and 28B are explanatory diagrams (3) showing the example when the formation of the electromagnetic coil assembly is performed in the yet other process. At the step shown in FIG. 28A, the resin 130 at the high temperature is injected from the resin injection holes 431 of the high-temperature die, and then, the molding die is defoamed using the vacuum pump. The protrusions of the parts of the convex portions 115A shown in FIG. 27B are embedded in the resin 130 and becomes less prominent. FIG. 28B shows a state in which the outer die 430 has been detached. Then, from the state shown in FIG. 28B, the base 400 and the core pin 411 are removed.

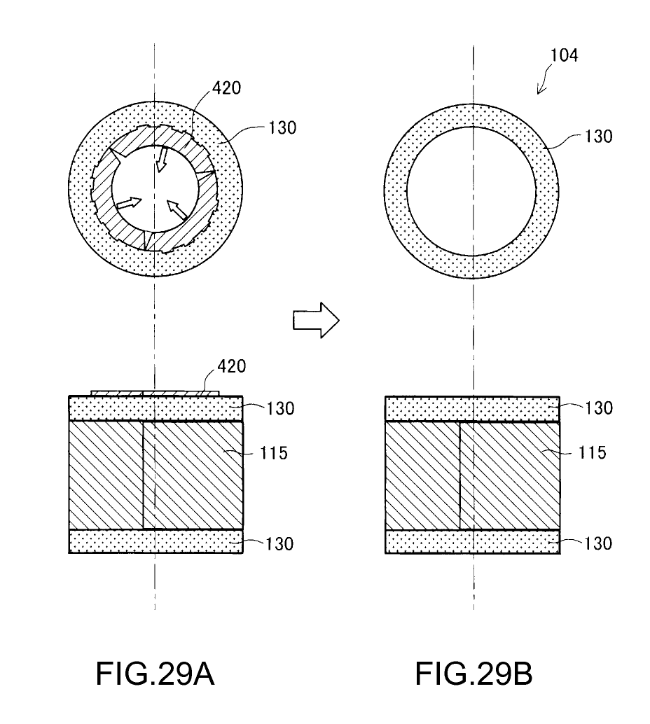

FIGS. 29A and 29B are explanatory diagrams (4) showing the example when the formation of the electromagnetic coil assembly is performed in the yet other process. The steps are the same as the steps shown in FIG. 19A and 19B, and their explanation will be omitted.

As described above, according to the second embodiment, the electromagnetic coil sub-assemblies 150 or the electromagnetic coil sub-assemblies with coil back yoke 155 are manufactured, assembled, and then, molded using the resin 130, and thereby, the electromagnetic coil assembly with coil back yoke 104 may be easily manufactured. As described above, the molding step may be executed according to various methods. Further, the electromagnetic coils 100A, 100B of the coreless motor 10 with the electromagnetic coil assembly with coil back yoke 104 have higher space factors, and have higher starting torque as has been explained in FIG. 10.

### Third Embodiment

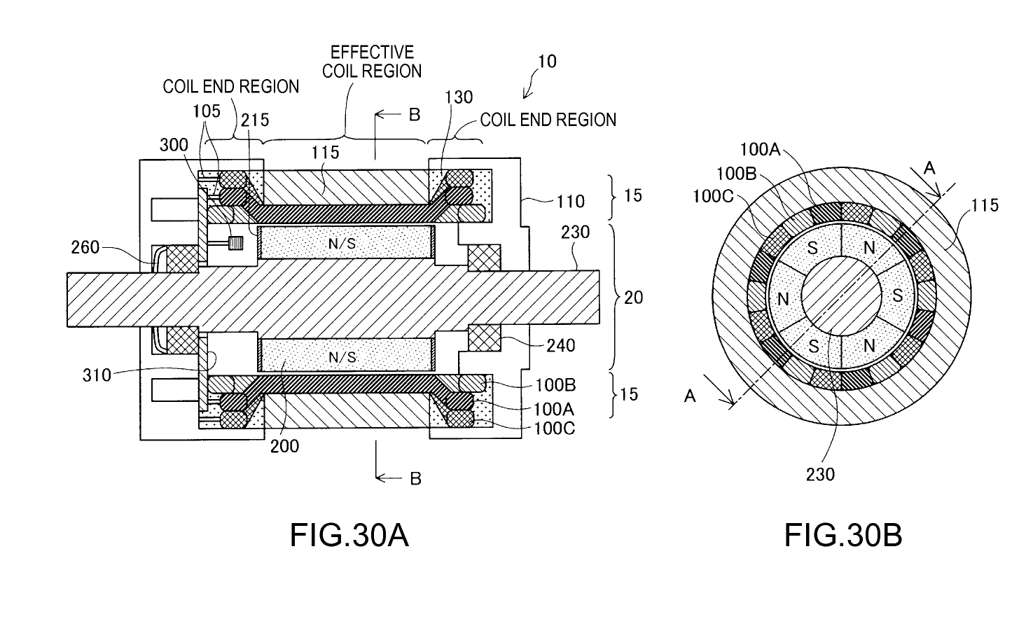

FIGS. 30A and 30B are explanatory diagrams showing the third embodiment. FIG. 30A is a diagram schematically showing a section of the coreless motor 10 cut along a section line (A-A in FIG. 30B) in parallel to the rotation axis 230 as seen from a direction perpendicular to the section, and FIG. 30B is a diagram schematically showing a section of the coreless motor 10 cut along a section line (B-B in FIG. 30A) perpendicular to the rotation axis 230 as seen from a direction perpendicular to the section. In the first and second embodiments, the cases of the two phases of electromagnetic coils have been explained, however, the third embodiment is different in that three phases of electromagnetic coils are used. Note that, in the case of three phases, the respective phases of electromagnetic coils 100A, 100B, 100C may be star-connected or delta-connected. Alternatively, the electromagnetic coils 100A, 100B, 100C may be respectively independent. In the third embodiment, the effective coil regions of the electromagnetic coils 100A, 100B, 100C are located on the same cylindrical surface, and the coil end regions of the two electromagnetic coils 100A, 100C are bent outward from the cylindrical surface on which the effective coil regions are provided. The size of the outward bent parts of the coil end regions of the two electromagnetic coils 100A from the cylindrical surface, 100C are different with respect to each phase, and the size of the outward bent parts of the coil end regions of the electromagnetic coil 100C from the cylindrical surface is larger than the size of the outward bent parts of the coil end regions of the electromagnetic coil 100A from the cylindrical surface. Note that a configuration in which the electromagnetic coil 100A is bent inward from the cylindrical surface on which the effective coil region is provided and the electromagnetic coil 100C is bent outward at the equal degree to the electromagnetic coil 100A in FIG. 30A from the cylindrical surface on which the effective coil region is provided may be employed. That is, electromagnetic coils having coil end regions bent outward from the cylindrical surface and electromagnetic coils having coil end regions bent inward from the cylindrical surface may be provided. Note that the electromagnetic coils 100A, 100B, 100C may be exchanged.

FIG. 30B is a diagram showing a modified example of the third embodiment. FIG. 30A is a diagram schematically showing a section of the coreless motor 10 cut along a section line (A-A in FIG. 30B) in parallel to the rotation axis 230 as seen from a direction perpendicular to the section, and FIG. 30B is a diagram schematically showing a section of the coreless motor 10 cut along a section line (B-B in FIG. 30A) perpendicular to the rotation axis 230 as seen from a direction perpendicular to the section. The modified example includes three phases of electromagnetic coils 100A to 100C like the third embodiment. However, like the second embodiment, the electromagnetic coils 100A to 100C form the electromagnetic coil sub-assemblies 150 and the structure of the electromagnetic coils is a structure in which the two electromagnetic coil sub-assemblies 150 are arranged in the circumference direction.

In the modified example, like the third embodiment, the effective coil regions of the electromagnetic coils 100A, 100B, 100C are located on the same cylindrical surface, and the coil end regions of the two electromagnetic coils 100A, 100C are bent outward from the cylindrical surface on which the effective coil regions are provided. The size of the outward bent parts of the coil end regions of the two electromagnetic coils 100A, 100C from the cylindrical surface are different with respect to each phase and the size of the outward bent parts of the coil end regions of the electromagnetic coil 100C is larger than the size of the outward bent parts of the coil end regions of the electromagnetic coil 100A. Note that a configuration in which the electromagnetic coil 100A is bent inward from the cylindrical surface on which the effective coil region is provided and the electromagnetic coil 100C is bent outward at the equal degree to the electromagnetic coil 100A in FIG. 30A from the cylindrical surface on which the effective coil region is provided may be employed. That is, electromagnetic coils having coil end regions bent outward from the cylindrical surface and electromagnetic coils having coil end regions bent inward from the cylindrical surface may be provided. Note that the electromagnetic coils 100A, 100B, 100C may be exchanged.

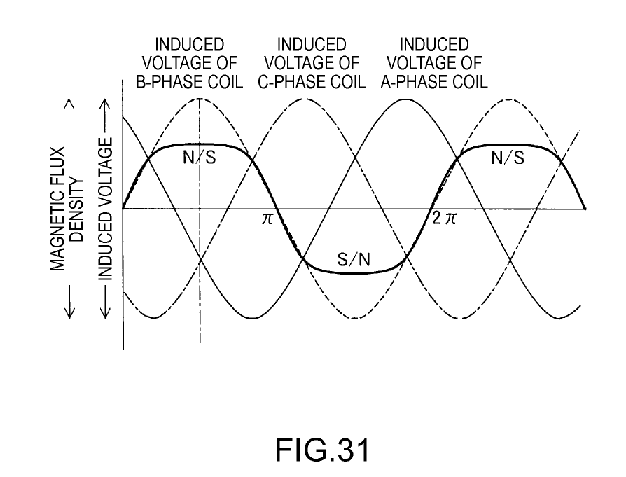

FIG. 31 is a graph showing an electrical angle of a coreless motor, induced voltages of electromagnetic coils, and magnetic flux density sensed by a magnetic sensor 300 (FIG. 30A). The magnetic flux density sensed by the magnetic sensor 300 becomes the maximum when the electrical angle is π/2 (3π/2), and becomes the minimum when the electrical angle is 0 (π, 2π). Further, the induced voltage of the electromagnetic coil 100B becomes the maximum when the electrical angle is π/2 (3π/2), and becomes zero when the electrical angle is 0 (π, 2π). On the other hand, the induced voltage of the electromagnetic coil 100A becomes the maximum when the electrical angle is 5π/6 (11π/6), and becomes zero when the electrical angle is π/3 (4π/3). The induced voltage of the electromagnetic coil 100C becomes the maximum when the electrical angle is 1π/6 (7π/6), and becomes zero when the electrical angle is 2π/3 (5π/3). That is, the induced voltages respectively generated in the electromagnetic coils 100A, 100B, 100C are shifted by 2π/3.

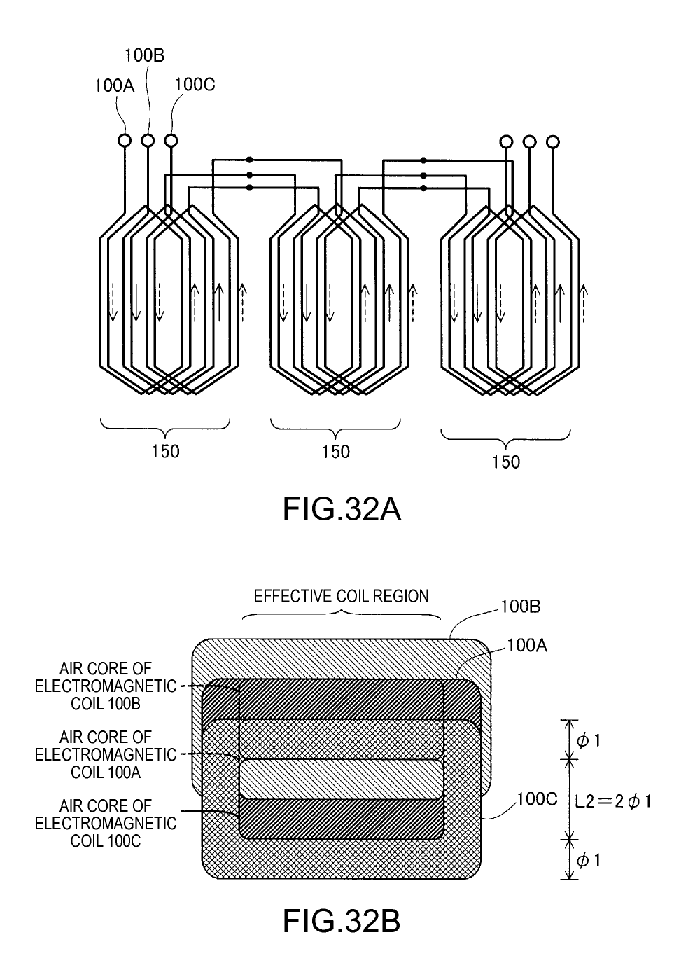

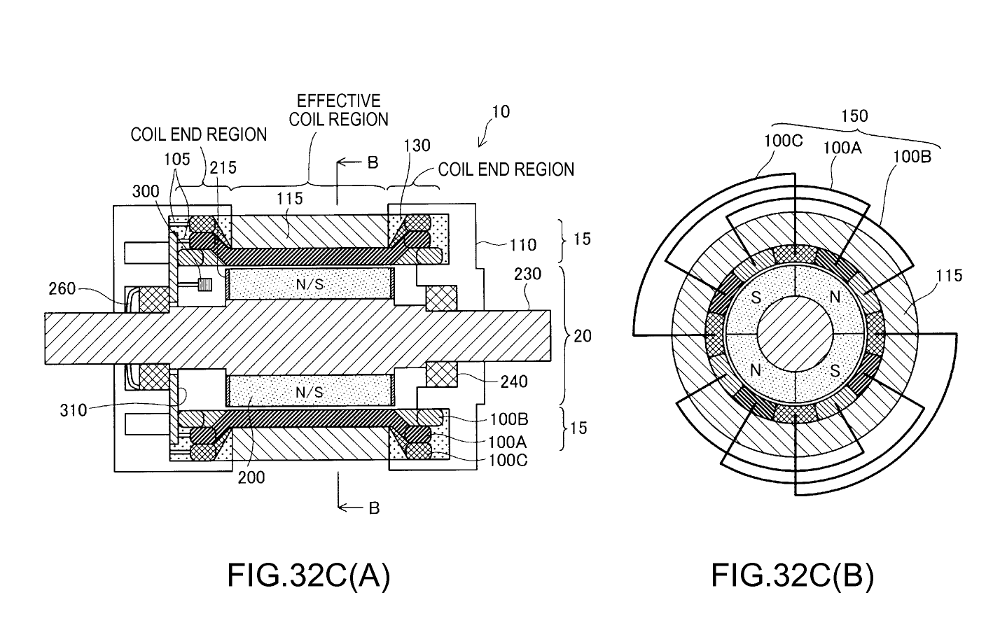

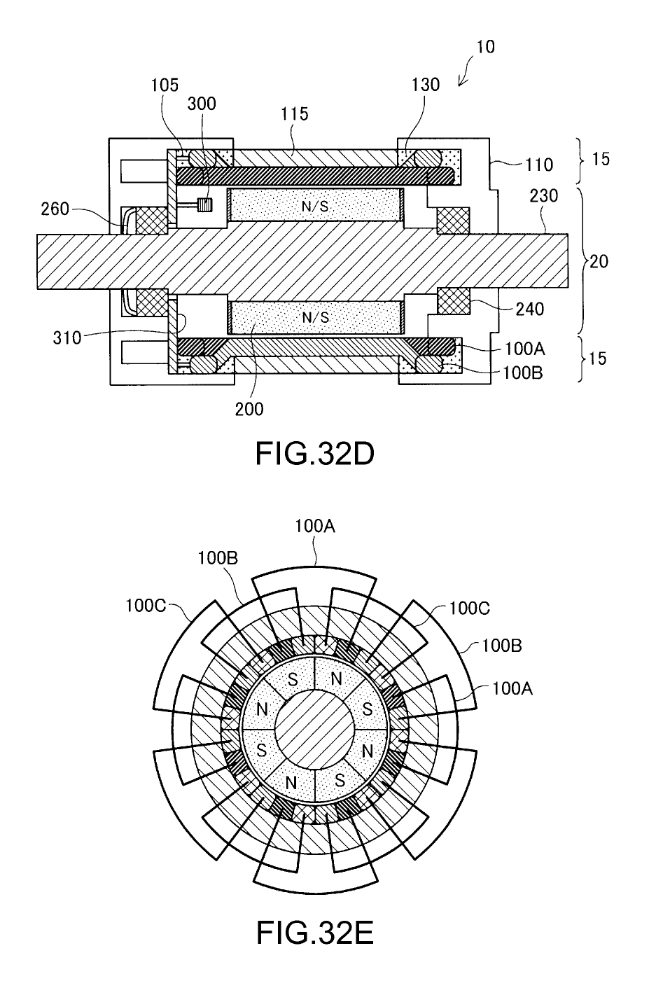

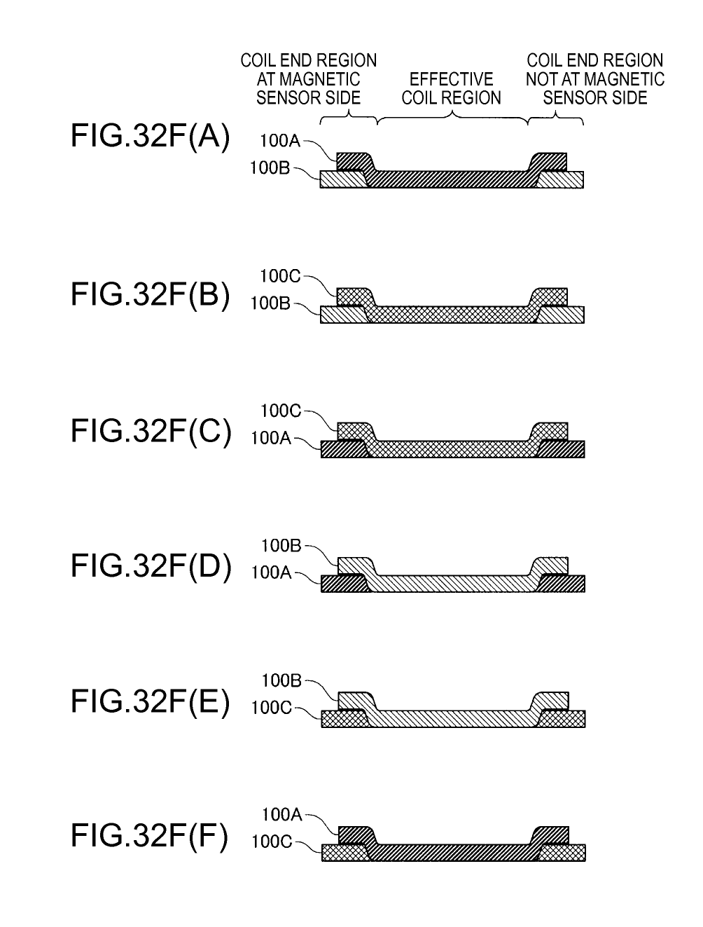

FIG. 32A is an explanatory diagram schematically showing wiring of the electromagnetic coils in the third embodiment. Like the second embodiment shown in FIG. 8, the electromagnetic coils 100A, 100B, 100C may be easily divided into plural (three in the embodiment) electromagnetic coil sub-assemblies 150. That is, in the third embodiment, the electromagnetic coil assembly with coil back yoke 104 may be easily formed by creating the electromagnetic coil sub-assemblies 150 and combining the electromagnetic coil sub-assemblies 150. Note that the electromagnetic coil sub-assemblies with coil back yoke 155 may be used.

FIG. 32B is an explanatory diagram schematically showing the electromagnetic coils in the third embodiment. It is known that the electromagnetic coils 100A, 100B, 100C overlap, in the air core part of the electromagnetic coil 100A, the effective coil regions of the other electromagnetic coils 100B, 100C are embedded, in the air core part of the electromagnetic coil 100B, the effective coil regions of the other electromagnetic coils 100C, 100A are embedded, and, in the air core part of the electromagnetic coil 100C, the effective coil regions of the other electromagnetic coils 100A, 100B are embedded. Note that, given that the width of the effective coil regions of the respective electromagnetic coils 100A to 100C is φ1, the distance L2 between the two effective coil regions is 2×φ1 in the respective electromagnetic coils 100A to 100C. In the case of typical M phases, given that the width of the effective coil regions is φ1, the distance L2 between the two effective coil regions is (M-1)×φ1 in the respective electromagnetic coils.

In the three-phase coreless motor 10 as shown in the third embodiment, like the coreless motor of the second embodiment, facilitation of the manufacturing process and improvement in space factor may be realized. The same advantages may be obtained in multiphase motors of four or more phases. FIG. 32C illustrates explanatory diagrams showing a modified example of the third embodiment. (A) in FIG. 32C is a diagram schematically showing a section of the coreless motor 10 cut along a section line (A-A in (B) in FIG. 32C) in parallel to the rotation axis 230 as seen from a direction perpendicular to the section, and (B) in FIG. 32C is a diagram schematically showing a section of the coreless motor 10 cut along a section line (B-B in (A) in FIG. 32C) perpendicular to the rotation axis 230 as seen from a direction perpendicular to the section. The modified example includes the three phases of electromagnetic coils 100A to 100C like the third embodiment, and the electromagnetic coil sub-assembly 150 is formed from one electromagnetic coil of each phase. The modified example is different in that the number of electromagnetic coil sub-assemblies 150 is two and the permanent magnet 200 has four poles.

In the modified example, like the third embodiment, the effective coil regions of the electromagnetic coils 100A, 100B, 100C are located on the same cylindrical surface, and the coil end regions of the two electromagnetic coils 100A, 100C are bent outward from the cylindrical surface on which the effective coil regions are provided. The size of the outward bent parts of the coil end regions of the two electromagnetic coils 100A, 100C from the cylindrical surface is different with respect to each phase, and the size of the outward bent parts of the coil end regions of the electromagnetic coil 100C from the cylindrical surface is larger than the size of the outward bent parts of the coil end regions of the electromagnetic coil 100A from the cylindrical surface. Note that a configuration in which the electromagnetic coil 100A is bent inward from the cylindrical surface on which the effective coil region is provided and the electromagnetic coil 100C is bent outward at the equal degree to the electromagnetic coil 100A in FIG. 30A from the cylindrical surface on which the effective coil region is provided may be employed. That is, electromagnetic coils having coil end regions bent outward from the cylindrical surface and electromagnetic coils having coil end regions bent inward from the cylindrical surface may be provided. Note that the electromagnetic coils 100A, 100B, 100C may be exchanged.

### Fourth Embodiment

FIG. 32D is an explanatory diagram showing the fourth embodiment. In the third embodiment, the coil end regions of the electromagnetic coils have a thickness of three layers because the electromagnetic coils are threefold as shown in FIG. 30A, for example. The fourth embodiment has three phases, but coil end regions of electromagnetic coils may be two layers.

FIG. 32E is an explanatory diagram schematically showing a section structure when the fourth embodiment is cut along a plane perpendicular to a rotation axis 230. Here, the arcs drawn outside from the electromagnetic coils show the shapes of the coil end regions of the electromagnetic coils. The outer arcs indicate that the coil end regions are bent outward from the cylindrical region containing the effective coil regions. The inner arcs indicate that the coil end regions are not bent outward or inward from the cylindrical region containing the effective coil regions. Note that, when the coil end regions are not bent outward or inward from the cylindrical region containing the effective coil regions, the arcs are drawn on the hatching showing the electromagnetic coils, however, in FIG. 32E, for convenience, the arcs are drawn outside of the hatching showing the electromagnetic coils because the arcs are hard to be seen if they are drawn on the hatching.

In the fourth embodiment, there are respective four of the A-phase to C-phase electromagnetic coils 100A to 100C, and the coil end regions of the two electromagnetic coils for each phase are bent outward as indicated by the outer arcs and the other respective two electromagnetic coils are not bent as indicated by the inner arcs. Further, for each phase, the electromagnetic coils having the coil end regions at the magnetic sensor side bent outward and the electromagnetic coils having the coil end regions at the magnetic sensor side not bent are alternately provided in the equal number.

FIG. 32F illustrates explanatory diagrams schematically showing sections when the fourth embodiment is cut along a plane in parallel to the rotation axis 230. FIG. 32F illustrates the sections cut along planes in parallel to the rotation axis 230 shifted by 30°. Here, in FIGS. 32F, the upper sides of the drawings are outside. The coil end regions of the electromagnetic coil 100A are bent outward (upward in the drawing) in (F) and (A) in FIG. 32F, and not bent in (C) and (D) in FIG. 32F. Similarly, the coil end regions of the electromagnetic coil 100B are bent outward in (D) and (E) in FIG. 32F, and not bent in (A) and (B) in FIG. 32F. Further, the coil end regions of the electromagnetic coil 100C are bent outward in (B) and (C) in FIG. 32F, and not bent in (E) and (F) in FIG. 32F. Here, the electromagnetic coils having the coil end regions bent outward are referred to as “first electromagnetic coils” or “first shape electromagnetic coils”, and the electromagnetic coils having the coil end regions not bent inward or outward are referred to as “second electromagnetic coils” or “second shape electromagnetic coils”. In the embodiment, all of the electromagnetic coils 100A to 100C have the first and second electromagnetic coils respectively in the equal number.

In the third embodiment, the C-phase electromagnetic coils 100C have the coil end regions largely bent toward the coil back yoke side, the A-phase electromagnetic coils 100A have the coil end regions bent toward the coil back yoke side, and the B-phase electromagnetic coils 100B have the coil end regions not bent. That is, the A-phase to C-phase electromagnetic coils have different shapes of the coil end regions. The electrical characteristics of the electromagnetic coils 100A to 100C depend mainly on the effective coil regions, and the electrical characteristics of inductances or the like are nearly the same, but, in a precise sense, they are slightly different depending on the differences in shapes of the coil end regions. On the other hand, in the fourth embodiment, the respective two first electromagnetic coils (first shape electromagnetic coils) having the coil end regions bent outward and two second electromagnetic coils (second shape electromagnetic coils) having the coil end regions not bent are provided with respect to the A-phase to C-phase electromagnetic coils 100A to 100C, and the electrical characteristics of the A-phase to C-phase first electromagnetic coils are the same. Further, the electrical characteristics of the A-phase to C-phase second electromagnetic coils are the same. Therefore, the electrical characteristics of the A-phase, B-phase, C-phase electromagnetic coils are the same. Thus, the coreless motor of the fourth embodiment is well balanced because the torque is hard to vary due to imbalance between the phases, and the efficiency may be improved.

In comparison between the third and fourth embodiments, the fourth embodiment has the following features. That is, in the third embodiment, there are parts in which the arcs are threefold as shown in FIG. 32C. For example, this means that there are parts in which the coil end regions overlap threefold as shown in FIG. 32C. On the other hand, in the fourth embodiment, as shown in FIG. 32E, the arcs are twofold at the maximum. That is, in the fourth embodiment, even in three phases, the overlapping of the coil end regions may be twofold at the maximum like the first embodiment shown in FIGS. 1A and 1B. Therefore, the size of the coreless motor 10 may be made smaller.

Note that, in the fourth embodiment, the configuration in which the coil end regions of the first electromagnetic coils are bent toward outside of the cylindrical surface containing the cylindrical region and the coil end regions of the second electromagnetic coils are not bent has been employed, however, for example, a configuration in which the coil end regions of the first electromagnetic coils are bent toward outside of the cylindrical surface containing the cylindrical region and the coil end regions of the second electromagnetic coils are bent toward inside of the cylindrical surface containing the cylindrical region, or a configuration in which the coil end regions of the first electromagnetic coils are bent toward inside of the cylindrical surface containing the cylindrical region, not toward outside of the cylindrical surface containing the cylindrical region and the coil end regions of the second electromagnetic coils are not bent may be employed. Further, in the fourth embodiment, the case of the three phases of electromagnetic coils has been explained as an example, however, the number of phases is not limited to three but may be two or more. Note that, in the case of three phases (in the case of an odd number of phases), the electromagnetic coils 100A to 100C respectively have the same number of first electromagnetic coils and second electromagnetic coils, however, in the case of two phases (in the case of an even number of phases), the electromagnetic coils 100A are the first electromagnetic coils and the electromagnetic coils 100B are the second electromagnetic coils. That is, when the number of phases is an odd number, the same number of first electromagnetic coils and second electromagnetic coils are provided with respect to the same phase electromagnetic coils, and, in the case of the even number of phases, when the phase is determined, the shape of the electromagnetic coils is determined to be the shape of the first electromagnetic coils or the second electromagnetic coils.

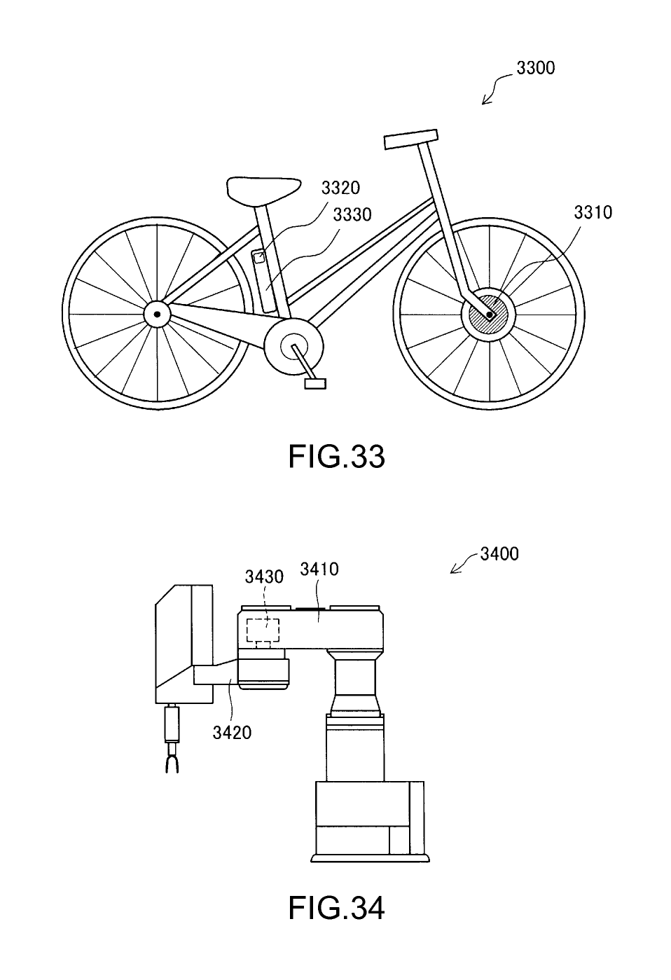

FIG. 33 is an explanatory diagram showing an electric bicycle (electric power-assisted bicycle) as an example of a mobile unit using a motor/power generator according to a modified example of the invention. In the bicycle 3300, a motor 3310 is provided on the front wheel, and a control circuit 3320 and a rechargeable battery 3330 are provided on the frame below the saddle. The motor 3310 assists traveling by driving the front wheel using power from the rechargeable battery 3330.

Further, at braking, the power regenerated in the motor 3310 is charged in the rechargeable battery 3330. The control circuit 3320 is a circuit of controlling driving and regeneration of the motor. As the motor 3310, the above described various coreless motors 10 may be used.

FIG. 34 is an explanatory diagram showing an example of a robot using a motor according to a modified example of the invention. The robot 3400 has first and second arms 3410, 3420, and a motor 3430. The motor 3430 is used when the second arm 3420 as a driven member is horizontally rotated. As the motor 3430, the above described various coreless motors 10 may be used.

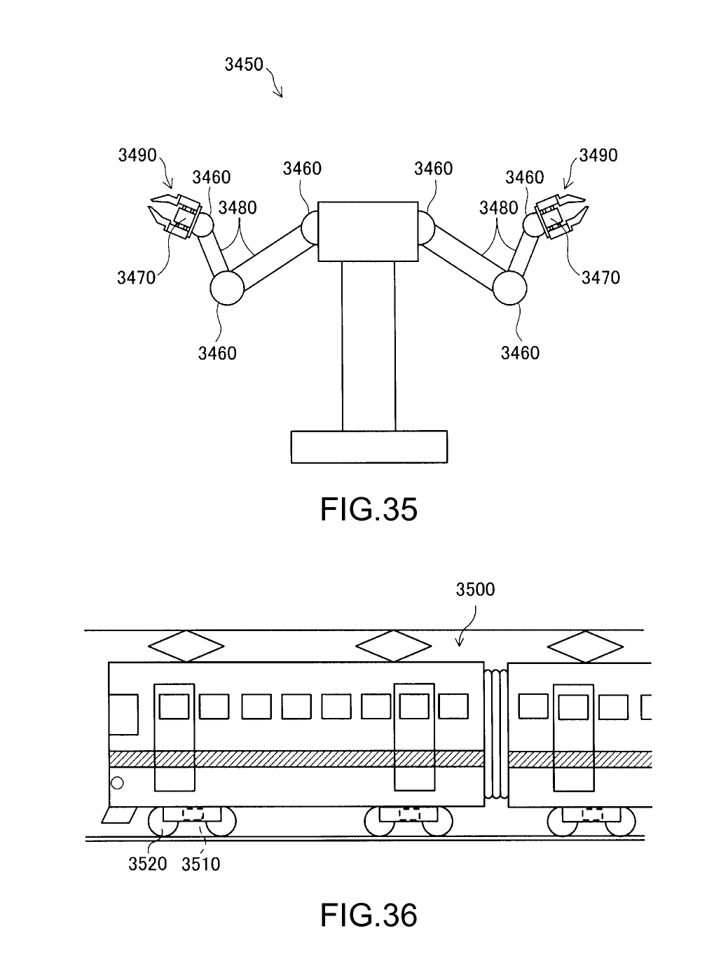

FIG. 35 is an explanatory diagram showing an example of a double-arm seven-axial robot using a motor according to a modified example of the invention. The double-arm seven-axial robot 3450 includes joint motors 3460, grasp part motors 3470, arms 3480, and grasp parts 3490. The joint motors 3460 are provided in locations corresponding to shoulder joints, elbow joints, and wrist joints. As the joint motors 3460, two motors for each joint are provided for three-dimensional movement of the arms 3480 and the grasp parts 3490. Further, the grasp part motors 3470 open and close the grasp parts 3490 and allow the grasp parts 3490 to grasp objects. In the double-arm seven-axial robot 3450, as the joint motors 3460 or the grasp part motors 3470, the above described various coreless motors 10 may be used.

FIG. 36 is an explanatory diagram showing a railway vehicle using a motor according to a modified example of the invention. The railway vehicle 3500 has electric motors 3510 and wheels 3520. The electric motors 3510 drive the wheels 3520. Further, the electric motors 3510 are used as power generators at braking of the railway vehicle 3500, and power is regenerated. As the electric motors 3510, the above described various coreless motors 10 may be used.

As above, the embodiments of the invention have been explained according to some examples, however, the embodiments of the invention facilitate understanding of the invention, but do not limit the invention. Obviously, the invention may be changed or altered without departing from the scope and the claims, and the invention includes equivalents thereof.

The present application claims the priority based on Japanese Patent Application No. 2011-215035 filed on Sep. 29, 2011, the disclosure of which is hereby incorporated by reference in its entirety.

What is claimed is:

1. A coreless electromechanical device having first and second cylindrical members movable relative to each other, the device comprising:
permanent magnets provided in the first member;
M (M is an integer number equal to or more than two) phases of α-wound air core electromagnetic coils provided in the second member; and
a coil back yoke provided in the second member,
wherein the electromagnetic coil has two effective coil regions that generate force for relative rotational transfer of the first member with respect to the second member and two coil end regions,
a total of the M electromagnetic coils respectively selected for each phase from the M phases of electromagnetic coils form a coil sub-assembly,
in the coil sub-assembly,
shapes of the effective coil regions of the M phases of electromagnetic coils respectively have the same shape, the effective coil regions extend along a direction in parallel to an axis direction of the rotation in a cylindrical region between the permanent magnets and the coil back yoke, and the whole M phases of electromagnetic coils are arranged in a circumference direction of the cylindrical region,
a distance between the two effective coil regions of the electromagnetic coil is (M-1) times a width of the electromagnetic coil in the effective coil region of the electromagnetic coil,
a first phase of electromagnetic coils of the M phases of electromagnetic coils have one effective coil region of the two effective coil regions of the other (M-1) phases of electromagnetic coils than the first phase of electromagnetic coils between the two effective coil regions, and
the coil end regions of at least the (M-1) phases of electromagnetic coils of the M phases of electromagnetic coils are bent toward an inner circumference side or an outer circumference side of a cylindrical surface containing the cylindrical region so as not to interfere with the coil end regions of the other phases of electromagnetic coils, and
the coil sub-assemblies are arranged in contact with the adjacent coil sub-assemblies in the circumference direction of the cylindrical region.

2. The coreless electromechanical device according to claim 1, wherein the coil end regions of the first phase of electromagnetic coils are not bent and provided on the cylindrical surface.

3. The coreless electromechanical device according to claim 2, including the electromagnetic coils having the coil end regions bent toward outside of the cylindrical surface and the electromagnetic coils having the coil end regions bent toward inside of the cylindrical surface.

4. The coreless electromechanical device according to claim 3, wherein, when a value of M is equal to or more than three, the coil end regions of the electromagnetic coils are bent toward the inner circumference side or the outer circumference side of the cylindrical region indifferent sizes with respect to each phase.

5. The coreless electromechanical device according to claim 4, wherein the shapes of the coil end regions of the electromagnetic coils included in the respective phases of groups of coils before bent are the same shape and the electromagnetic coils have the same electrical resistance value.

6. The coreless electromechanical device according to claim 5, wherein materials of conductors forming the electromagnetic coils are the same material, diameters of the conductors are the same, the numbers of turns of the conductors of the electromagnetic coils are the same, and the electromagnetic coils have the same electrical resistance value.

7. A mobile unit comprising the coreless electromechanical device according to claim 6.

8. A robot comprising the coreless electromechanical device according to claim 6.

9. A manufacturing method of a coreless electromechanical device having M (M is an integer number equal to or more than two) phases of α-wound electromagnetic coils, the method comprising:
(a) preparing M cylindrical pieces of the α-wound electromagnetic coils respectively having effective coil regions of the electromagnetic coils in the same shape and having electric resistance values of the electromagnetic coils in the same magnitude by winding a conductor at N (N is an integer number equal to or more than two) times;
(b) bending coil end regions of at least (M-1) electromagnetic coils of the M electromagnetic coils toward inner circumference sides or outer circumference sides of the cylindrical pieces not to interfere with the coil end regions of the other electromagnetic coils;
(c) forming a coil sub-assembly having a structure in which a first phase of electromagnetic coils include one effective coil region of the two effective coil regions of the other (M-1) phases of electromagnetic coils than the first phase of electromagnetic coils between the two effective coil regions using a total of M cylindrical pieces of electromagnetic coils for each phase from the cylindrical pieces of the M phases of electromagnetic coils;
(d) forming the electromagnetic coils provided in a cylindrical shape by arranging the P (P is an integer number equal to or more than two) coil sub-assemblies in a circumference direction of a cylindrical region so that the adjacent coil sub-assemblies may be in contact;
(e) providing a coil back yoke at an outer circumference side of the cylindrical region of the electromagnetic coils provided in the cylindrical shape; and
(f) providing a rotation axis having permanent magnets at an inner circumference side of the cylindrical region of the electromagnetic coils provided in the cylindrical shape.

10. A manufacturing method of a coreless electromechanical device having M (M is an integer number equal to or more than two) phases of electromagnetic coils, the method comprising:
(a) preparing P (P is an integer number equal to or more than two) cylindrical pieces of the electromagnetic coils respectively having effective coil regions of the electromagnetic coils in the same shape and having electric resistance values of the electromagnetic coils in the same magnitude with respect to each phase by winding a conductor at N (N is an integer number equal to or more than two) times;
(b) bending coil end regions of at least the (M-1) phases of electromagnetic coils of the M phases of electromagnetic coils toward inner circumference sides or outer circumference sides of the cylindrical pieces not to interfere with the coil end regions of the other phases of electromagnetic coils;
(c) forming a coil sub-assembly having a structure in which a first phase of electromagnetic coils include one effective coil region of the two effective coil regions of the other (M-1) phases of electromagnetic coils than the first phase of electromagnetic coils between the two effective coil regions using a total of M cylindrical pieces of electromagnetic coils for each phase from the cylindrical pieces of the M phases of electromagnetic coils;
(d) preparing a coil back yoke having a cylindrical shape;
(e) forming the electromagnetic coils provided in a cylindrical shape by arranging the P coil sub-assemblies at an inner circumference side of the coil back yoke in a circumference direction of a cylindrical region so that the adjacent coil sub-assemblies may be in contact; and
(f) providing a rotation axis having permanent magnets at an inner circumference side of the cylindrical region of the electromagnetic coils provided in the cylindrical shape.
